(19) United States
(12) Patent Application Publication
(10) Pub. No.: US 2024/0067195 A1
(43) Pub. Date: Feb. 29, 2024

(54) Transfer Learning with Experience Filter for Vehicle Operation

(71) Applicants: Nissan North America, Inc., Franklin, TN (US); The Board of Trustees of the Leland Stanford Junior University, Stanford, CA (US)

(72) Inventors: Kyle Hollins Wray, Mountain View, CA (US); Stefan Witwicki, San Carlos, CA (US); Mykel Kochenderfer, Palo Alto, CA (US); Anil Yildiz, Stanford, CA (US); Esen Yel, Redwood City, CA (US); Anthony Corso, Palo Alto, CA (US)

(21) Appl. No.: 17/900,311

(22) Filed: Aug. 31, 2022

(51) Int. Cl. B60W 50/06; B60W 60/00; G06N 7/00; G06N 20/00

(52) U.S. Cl. CPC B60W 50/06; B60W 60/001; G06N 7/005; G06N 20/00; B60W 2540/30; B60W 2555/20

(57) ABSTRACT

A group of state-action history entries may be determined from state-action history entries stored in a database. A state-action history entry may represent an experienced operational scenario. A state-action history entry may be associated with a feature. The group of state-action history entries may be determined based on a similarity of the feature. A parameter may be generated based on the group of state-action history entries. The parameter may represent a probability associated with experienced operational scenarios that are similar to one another. A model may be generated based on the parameter. The model may be configured for use in an operational scenario that is similar to the experienced operational scenarios when traversing a portion of the vehicle transportation network.

### TECHNICAL FIELD

This disclosure relates generally to autonomous vehicle operational management and autonomous driving, and more particularly to autonomous vehicle operation that uses transfer learning with an experience filter for vehicle operation.

### BACKGROUND

A vehicle, such as an autonomous vehicle, may traverse a portion of a vehicle transportation network (e.g., a road). Traversing the portion of the vehicle transportation network may include generating or capturing, such as by a sensor of the vehicle, data representing an operational state or environment, or a portion thereof, of the vehicle. This data may be used for localization of the vehicle within the vehicle transportation network.

### SUMMARY

Disclosed herein are aspects, features, elements, implementations, and embodiments of autonomous vehicle operation using transfer learning with an experience filter.

An aspect of the disclosed embodiments is a method for use in traversing a vehicle transportation network. The method includes determining a group of state-action history entries from state-action history entries stored in a database, wherein a state-action history entry represents an experienced operational scenario, wherein a state-action history entry is associated with a feature, and wherein the group of state-action history entries is determined based on a similarity of the feature; generating a parameter based on the group of state-action history entries, wherein the parameter represents a probability associated with experienced operational scenarios that are similar to one another; and generating a model based on the parameter, wherein the model is configured for use in an operational scenario that is similar to the experienced operational scenarios when traversing a portion of the vehicle transportation network.

Another aspect of the disclosed embodiments is an apparatus for use in traversing a vehicle transportation network that includes a non-transitory computer readable medium and a processor. The processor is configured to execute instructions stored on the non-transitory computer readable medium to determine a group of state-action history entries from state-action history entries stored in a database, wherein a state-action history entry represents an experienced operational scenario, wherein a state-action history entry is associated with a feature, and wherein the group of state-action history entries is determined based on a similarity of the feature; generate a parameter based on the group of state-action history entries, wherein the parameter represents a probability associated with experienced operational scenarios that are similar to one another; and generate a model based on the parameter, wherein the model is configured for use in an operational scenario that is similar to the experienced operational scenarios when traversing a portion of a vehicle transportation network.

Variations in these and other aspects, features, elements, implementations, and embodiments of the methods, apparatus, procedures, and algorithms disclosed herein are described in further detail hereafter.

### BRIEF DESCRIPTION OF THE DRAWINGS

The various aspects of the methods and apparatuses disclosed herein will become more apparent by referring to the examples provided in the following description and drawings in which like reference numbers refer to like elements unless otherwise noted.

FIG. 1 is a diagram of an example of a vehicle in which the aspects, features, and elements disclosed herein may be implemented.

FIG. 2 is a diagram of an example of a portion of a vehicle transportation and communication system in which the aspects, features, and elements disclosed herein may be implemented.

FIG. 3 is a diagram of a portion of a vehicle transportation network in accordance with this disclosure.

FIG. 4 is a diagram of an example of an autonomous vehicle operational management system in accordance with embodiments of this disclosure.

FIG. 5 is a flow chart diagram of an example of a process for controlling the operation of a vehicle in accordance with embodiments of this disclosure.

FIG. 6 is a flow chart diagram of a process for use in traversing a vehicle transportation network in accordance with embodiments of this disclosure.

FIG. 7 is a diagram of operational scenarios, including traversing an intersection and encountering a crosswalk, used to explain the process of FIG. 6.

FIG. 8 is a diagram of an operational scenario, including changing lanes, used to explain the process of FIG. 6.

FIG. 9 is a diagram of an example of a system using transfer learning with an experience filter to determine a group of state-action history entries.

FIG. 10 is a diagram of an example of state-action history entries stored in a database.

### DETAILED DESCRIPTION

A vehicle, such as an autonomous vehicle, or a semi-autonomous vehicle, may traverse a portion of a vehicle transportation network. The vehicle may include one or more sensors and traversing the vehicle transportation network may include the sensors generating or capturing sensor data for use in traversing the vehicle transportation network. Sensor data may include vehicle operational information, such as global positioning system (GPS) coordinates, whether the vehicle is moving or in a fixed position, a vehicle heading, etc. Sensor data may also include information corresponding to the operational environment of the vehicle, such as information corresponding to one or more external objects, such as pedestrians, remote vehicles, other objects within the vehicle operational environment, vehicle transportation network geometry or topology, or a combination thereof. This information may be referred to herein as operational environment information.

The autonomous vehicle may include an autonomous vehicle operational management system, which may include one or more operational environment monitors that may process operational environment information, such as the sensor data, for the autonomous vehicle. The operational management system may include a learning monitor that may determine probability of a vehicle control action based on a stored observation of the operational environment, and/or a blocking monitor that may determine probability of availability information for portions of the vehicle transportation network spatiotemporally proximate to the autonomous vehicle.

The autonomous vehicle operational management system may include an autonomous vehicle operational management controller, or executor, which may detect one or more operational scenarios, such as pedestrian scenarios, intersection scenarios, lane change scenarios, or any other vehicle operational scenario or combination of vehicle operational scenarios, corresponding to the external objects.

The autonomous vehicle operational management system may include one or more scenario-specific operational control evaluation modules. Each scenario-specific operational control evaluation module may be a model, such as a Partially Observable Markov Decision Process (POMDP) model, of a respective operational scenario. That is, each model is configured to handle a specific scenario. The autonomous vehicle operational management controller may instantiate respective instances of the scenario-specific operational control evaluation modules in response to detecting the corresponding operational scenarios.

The autonomous vehicle operational management controller may receive candidate vehicle control actions from respective instantiated scenario-specific operational control evaluation module (SSOCEM) instances, may identify a vehicle control action from the candidate vehicle control actions, and may control the autonomous vehicle to traverse a portion of the vehicle transportation network according to the identified vehicle control action.

Autonomous vehicles are programmed to perform scenario-specific actions. In the real world, however, it is impossible to predict every possible scenario and code corresponding solutions for every possible scenario into the autonomous vehicle system. To do so would take countless hours and teams of engineers to code every scenario and/or problem into the autonomous vehicle system.

Transfer learning is a technique that may be used to improve the learning process. With transfer learning, a learned solution to one operational scenario implies that it may be used in multiple other scenarios that may be similar. For example, the experiences learned in one intersection about another vehicle performing a rolling stop may be used to improve the model or expected value. This learned experience may be used at a different intersection to improve the vehicle reaction to a rolling stop of another vehicle.

While transfer learning may permit determining responses to multiple scenarios relatively quickly, in some cases, the responses might not be optimal for the scenarios. For example, changing the model or expected value based on an experience at an intersection in a rural region or one part of the world could possibly result in a less optimal response when using the model or expected value at an intersection in an urban region or another part of the world.

Techniques described herein may use transfer learning with an experience filter for operation of an autonomous vehicle. A collection of state-action history entries may be stored in a database (e.g., an experience database). An individual state-action history entry may include state-action samples that are collected when experiencing an operational scenario (e.g., when traversing an intersection, changing lanes, or encountering a crosswalk). Thus, an individual state-action history entry may represent an experienced operational scenario. A state of a state-action sample could include, for example, sensor data, received from a sensor of the vehicle, which could be collected for a portion of an operational environment during an operational scenario. An action of a state-action sample could include, for example, the vehicle being controlled to stop, edge (e.g., move forward slowly), go (e.g., move forward quickly), or otherwise being controlled with respect to velocity or position. An individual state-action history entry may be stored in the database with one or more features that may be determined when collecting the state-action samples (e.g., the state-action history entry may be categorized based on the one or more features). For example, the feature could be a coordinate location, a time of day, a density of traffic, a driver aggressiveness (e.g., speed of one or more other vehicles), an observability, or a vehicle characteristic (e.g., vehicle class, price, or performance).

A group of state-action history entries may be determined from the collection of state-action history entries that are stored in the database (e.g., experience filtering). The group may be determined based on a similarity of the one or more features. For example, the group may be determined based on state-action history entries having one or more similarities in coordinate location, time of day, density of traffic, driver aggressiveness, observability, and/or vehicle characteristic.

The group of state-action history entries may be used to generate a parameter (e.g., the group of state-action history entries may be parameterized). In some implementations, the group of state-action history entries may be parameterized to have a specific human-understandable term. Processing the one or more parameters (e.g., to generate a model) may be faster and/or more efficient than processing state-actions samples that may be arrayed in a large matrices. The parameter may represent a probability associated with experienced operational scenarios that are similar to one another. For example, the parameter may represent a probability associated with movement of a vehicle in experienced operational scenarios that are similar.

The parameter may be used to generate a model. For example, the parameter may be used to implement a Partially Observable Markov Decision Process (POMDP) or a Markov Decision Process (MDP) to generate a POMDP model and/or an MDP model. The model may be deployed and used when traversing a portion of the vehicle transportation network (e.g., transfer learning, with the benefit of experience filtering). In particular, the model may be used when encountering an operational scenario that is similar to the experienced operational scenarios. For example, the model may be used when traversing an intersection, changing lanes, or encountering a crosswalk that is similar to experienced intersections, lane changes, or crosswalks, as determined by the similarity in features. As a result, in some implementations, zero-shot transfer learning may be used to permit an autonomous vehicle to navigate an operational scenario. Thus, the rate of learning various operational scenarios may be improved while providing model accuracy.

Although described herein with reference to an autonomous vehicle, the methods and apparatus described herein may be implemented in any vehicle capable of autonomous or semi-autonomous operation. Although described with reference to a vehicle transportation network, the method and apparatus described herein may include the autonomous vehicle operating in any area navigable by the vehicle.

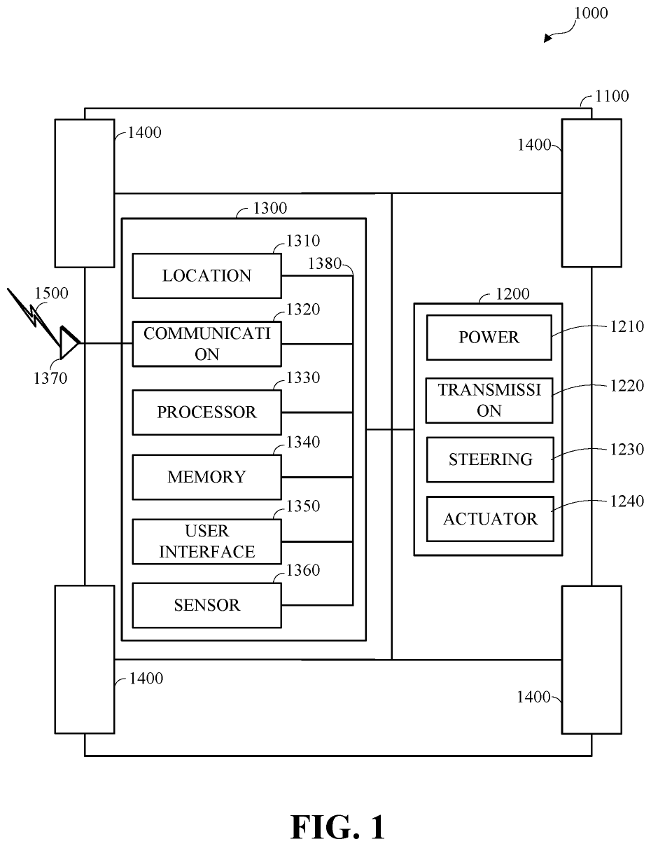

FIG. 1 is a diagram of an example of a vehicle in which the aspects, features, and elements disclosed herein may be implemented. In the embodiment shown, a vehicle 1000 includes a chassis 1100, a powertrain 1200, a controller 1300, and wheels 1400. Although the vehicle 1000 is shown as including four wheels 1400 for simplicity, any other propulsion device or devices, such as a propeller or tread, may be used. In FIG. 1, the lines interconnecting elements, such as the powertrain 1200, the controller 1300, and the wheels 1400, indicate that information, such as data or control signals, power, such as electrical power or torque, or both information and power, may be communicated between the respective elements. For example, the controller 1300 may receive power from the powertrain 1200 and may communicate with the powertrain 1200, the wheels 1400, or both, to control the vehicle 1000, which may include accelerating, decelerating, steering, or otherwise controlling the vehicle 1000.

The powertrain 1200 shown by example in FIG. 1 includes a power source 1210, a transmission 1220, a steering unit 1230, and an actuator 1240. Any other element or combination of elements of a powertrain, such as a suspension, a drive shaft, axles, or an exhaust system may also be included. Although shown separately, the wheels 1400 may be included in the powertrain 1200.

The power source 1210 includes an engine, a battery, or a combination thereof. The power source 1210 may be any device or combination of devices operative to provide energy, such as electrical energy, thermal energy, or kinetic energy. In an example, the power source 1210 includes an engine, such as an internal combustion engine, an electric motor, or a combination of an internal combustion engine and an electric motor, and is operative to provide kinetic energy as a motive force to one or more of the wheels 1400. Alternatively, or additionally, the power source 1210 includes a potential energy unit, such as one or more dry cell batteries, such as nickel-cadmium (NiCd), nickel-zinc (NiZn), nickel metal hydride (NiMH), lithium-ion (Li-ion); solar cells; fuel cells; or any other device capable of providing energy.

The transmission 1220 receives energy, such as kinetic energy, from the power source 1210, and transmits the energy to the wheels 1400 to provide a motive force. The transmission 1220 may be controlled by the controller 1300, the actuator 1240, or both. The steering unit 1230 controls the wheels 1400 to steer the vehicle and may be controlled by the controller 1300, the actuator 1240, or both. The actuator 1240 may receive signals from the controller 1300 and actuate or control the power source 1210, the transmission 1220, the steering unit 1230, or any combination thereof to operate the vehicle 1000.

In the illustrated embodiment, the controller 1300 includes a location unit 1310, an electronic communication unit 1320, a processor 1330, a memory 1340, a user interface 1350, a sensor 1360, and an electronic communication interface 1370. Fewer of these elements may exist as part of the controller 1300. Although shown as a single unit, any one or more elements of the controller 1300 may be integrated into any number of separate physical units. For example, the user interface 1350 and the processor 1330 may be integrated in a first physical unit and the memory 1340 may be integrated in a second physical unit. Although not shown in FIG. 1, the controller 1300 may include a power source, such as a battery. Although shown as separate elements, the location unit 1310, the electronic communication unit 1320, the processor 1330, the memory 1340, the user interface 1350, the sensor 1360, the electronic communication interface 1370, or any combination thereof may be integrated in one or more electronic units, circuits, or chips.

The processor 1330 may include any device or combination of devices capable of manipulating or processing a signal or other information now-existing or hereafter developed, including optical processors, quantum processors, molecular processors, or a combination thereof. For example, the processor 1330 may include one or more special purpose processors, one or more digital signal processors, one or more microprocessors, one or more controllers, one or more microcontrollers, one or more integrated circuits, one or more Application Specific Integrated Circuits, one or more Field Programmable Gate Array, one or more programmable logic arrays, one or more programmable logic controllers, one or more state machines, or any combination thereof. The processor 1330 is operatively coupled with one or more of the location unit 1310, the memory 1340, the electronic communication interface 1370, the electronic communication unit 1320, the user interface 1350, the sensor 1360, and the powertrain 1200. For example, the processor may be operatively coupled with the memory 1340 via a communication bus 1380.

The memory 1340 includes any tangible non-transitory computer-usable or computer-readable medium, capable of, for example, containing, storing, communicating, or transporting machine readable instructions, or any information associated therewith, for use by or in connection with any processor, such as the processor 1330. The memory 1340 may be, for example, one or more solid state drives, one or more memory cards, one or more removable media, one or more read-only memories, one or more random access memories, one or more disks, including a hard disk, a floppy disk, an optical disk, a magnetic or optical card, or any type of non-transitory media suitable for storing electronic information, or any combination thereof. For example, a memory may be one or more read only memories (ROM), one or more random access memories (RAM), one or more registers, low power double data rate (LPDDR) memories, one or more cache memories, one or more semiconductor memory devices, one or more magnetic media, one or more optical media, one or more magneto-optical media, or any combination thereof.

The communication interface 1370 may be a wireless antenna, as shown, a wired communication port, an optical communication port, or any other wired or wireless unit capable of interfacing with a wired or wireless electronic communication medium 1500. Although FIG. 1 shows the communication interface 1370 communicating via a single communication link, a communication interface may be configured to communicate via multiple communication links. Although FIG. 1 shows a single communication interface 1370, a vehicle may include any number of communication interfaces.

The communication unit 1320 is configured to transmit or receive signals via a wired or wireless electronic communication medium 1500, such as via the communication interface 1370. Although not explicitly shown in FIG. 1, the communication unit 1320 may be configured to transmit, receive, or both via any wired or wireless communication medium, such as radio frequency (RF), ultraviolet (UV), visible light, fiber optic, wireline, or a combination thereof. Although FIG. 1 shows a single communication unit 1320 and a single communication interface 1370, any number of communication units and any number of communication interfaces may be used. In some embodiments, the communication unit 1320 includes a dedicated short range communications (DSRC) unit, an on-board unit (OBU), or a combination thereof.

The location unit 1310 may determine geolocation information, such as longitude, latitude, elevation, direction of travel, or speed, of the vehicle 1000. In an example, the location unit 1310 includes a GPS unit, such as a Wide Area Augmentation System (WAAS) enabled National Marine-Electronics Association (NMEA) unit, a radio triangulation unit, or a combination thereof. The location unit 1310 can be used to obtain information that represents, for example, a current heading of the vehicle 1000, a current position of the vehicle 1000 in two or three dimensions, a current angular orientation of the vehicle 1000, or a combination thereof.

The user interface 1350 includes any unit capable of interfacing with a person, such as a virtual or physical keypad, a touchpad, a display, a touch display, a heads-up display, a virtual display, an augmented reality display, a haptic display, a feature tracking device, such as an eye-tracking device, a speaker, a microphone, a video camera, a sensor, a printer, or any combination thereof. The user interface 1350 may be operatively coupled with the processor 1330, as shown, or with any other element of the controller 1300. Although shown as a single unit, the user interface 1350 may include one or more physical units. For example, the user interface 1350 may include both an audio interface for performing audio communication with a person and a touch display for performing visual and touch-based communication with the person. The user interface 1350 may include multiple displays, such as multiple physically separate units, multiple defined portions within a single physical unit, or a combination thereof.

The sensors 1360 are operable to provide information that may be used to control the vehicle. The sensors 1360 may be an array of sensors. The sensors 1360 may provide information regarding current operating characteristics of the vehicle 1000, including vehicle operational information. The sensors 1360 can include, for example, a speed sensor, acceleration sensors, a steering angle sensor, traction-related sensors, braking-related sensors, steering wheel position sensors, eye tracking sensors, seating position sensors, or any sensor, or combination of sensors, that are operable to report information regarding some aspect of the current dynamic situation of the vehicle 1000.

The sensors 1360 include one or more sensors that are operable to obtain information regarding the physical environment surrounding the vehicle 1000, such as operational environment information. For example, one or more sensors may detect road geometry, such as lane lines, and obstacles, such as fixed obstacles, vehicles, and pedestrians. The sensors 1360 can be or include one or more video cameras, laser-sensing systems, infrared-sensing systems, acoustic-sensing systems, or any other suitable type of on-vehicle environmental sensing device, or combination of devices, now known or later developed. In some embodiments, the sensors 1360 and the location unit 1310 are combined.

Although not shown separately, the vehicle 1000 may include a trajectory controller. For example, the controller 1300 may include the trajectory controller. The trajectory controller may be operable to obtain information describing a current state of the vehicle 1000 and a route planned for the vehicle 1000, and, based on this information, to determine and optimize a trajectory for the vehicle 1000. In some embodiments, the trajectory controller may output signals operable to control the vehicle 1000 such that the vehicle 1000 follows the trajectory that is determined by the trajectory controller. For example, the output of the trajectory controller can be an optimized trajectory that may be supplied to the powertrain 1200, the wheels 1400, or both. In some embodiments, the optimized trajectory can be control inputs such as a set of steering angles, with each steering angle corresponding to a point in time or a position. In some embodiments, the optimized trajectory can be one or more paths, lines, curves, or a combination thereof.

One or more of the wheels 1400 may be a steered wheel that is pivoted to a steering angle under control of the steering unit 1230, a propelled wheel that is torqued to propel the vehicle 1000 under control of the transmission 1220, or a steered and propelled wheel that may steer and propel the vehicle 1000.

Although not shown in FIG. 1, a vehicle may include additional units or elements not shown in FIG. 1, such as an enclosure, a Bluetooth® module, a frequency modulated (FM) radio unit, a Near Field Communication (NFC) module, a liquid crystal display (LCD) display unit, an organic light-emitting diode (OLED) display unit, a speaker, or any combination thereof.

The vehicle 1000 may be an autonomous vehicle that is controlled autonomously, without direct human intervention, to traverse a portion of a vehicle transportation network. Although not shown separately in FIG. 1, an autonomous vehicle may include an autonomous vehicle control unit that performs autonomous vehicle routing, navigation, and control. The autonomous vehicle control unit may be integrated with another unit of the vehicle. For example, the controller 1300 may include the autonomous vehicle control unit.

When present, the autonomous vehicle control unit may control or operate the vehicle 1000 to traverse a portion of the vehicle transportation network in accordance with current vehicle operation parameters. The autonomous vehicle control unit may control or operate the vehicle 1000 to perform a defined operation or maneuver, such as parking the vehicle. The autonomous vehicle control unit may generate a route of travel from an origin, such as a current location of the vehicle 1000, to a destination based on vehicle information, environment information, vehicle transportation network information representing the vehicle transportation network, or a combination thereof, and may control or operate the vehicle 1000 to traverse the vehicle transportation network in accordance with the route. For example, the autonomous vehicle control unit may output the route of travel to the trajectory controller to operate the vehicle 1000 to travel from the origin to the destination using the generated route.

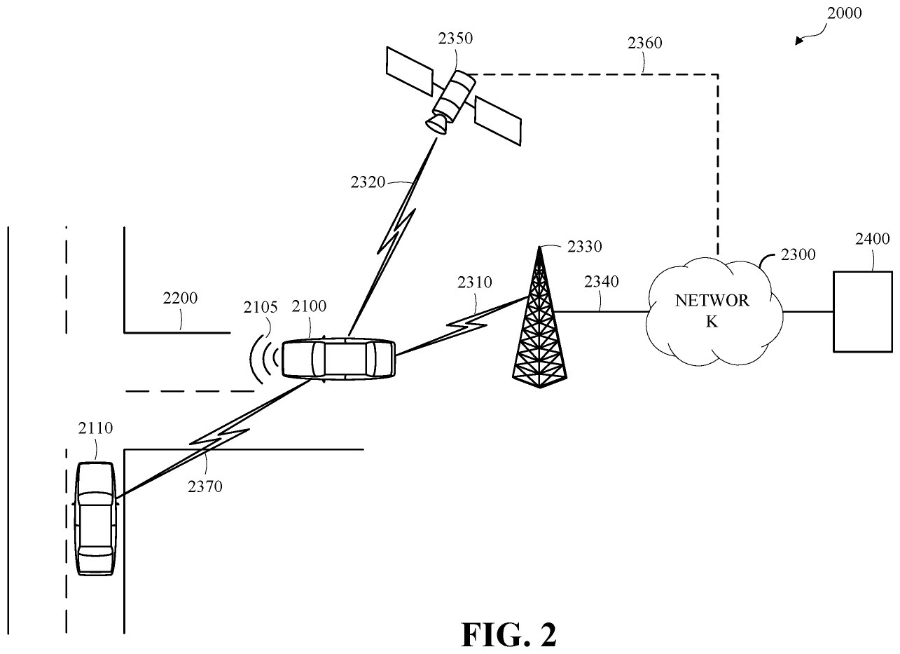

FIG. 2 is a diagram of an example of a portion of a vehicle transportation and communication system in which the aspects, features, and elements disclosed herein may be implemented. The vehicle transportation and communication system 2000 may include one or more vehicles 2100/2110, such as the vehicle 1000 shown in FIG. 1, which travels via one or more portions of the vehicle transportation network 2200, and communicates via one or more electronic communication networks 2300. Although not explicitly shown in FIG. 2, a vehicle may traverse an off-road area.

The electronic communication network 2300 may be, for example, a multiple access system that provides for communication, such as voice communication, data communication, video communication, messaging communication, or a combination thereof, between the vehicle 2100/2110 and one or more communication devices 2400. For example, a vehicle 2100/2110 may receive information, such as information representing the vehicle transportation network 2200, from a communication device 2400 via the network 2300.

In some embodiments, a vehicle 2100/2110 may communicate via a wired communication link (not shown), a wireless communication link 2310/2320/2370, or a combination of any number of wired or wireless communication links. As shown, a vehicle 2100/2110 communicates via a terrestrial wireless communication link 2310, via a non-terrestrial wireless communication link 2320, or via a combination thereof. The terrestrial wireless communication link 2310 may include an Ethernet link, a serial link, a Bluetooth link, an infrared (IR) link, an ultraviolet (UV) link, or any link capable of providing for electronic communication.

A vehicle 2100/2110 may communicate with another vehicle 2100/2110. For example, a host, or subject, vehicle (HV) 2100 may receive one or more automated inter-vehicle messages, such as a basic safety message (BSM), from a remote, or target, vehicle (RV) 2110, via a direct communication link 2370, or via a network 2300. The remote vehicle 2110 may broadcast the message to host vehicles within a defined broadcast range, such as 300 meters. In some embodiments, the host vehicle 2100 may receive a message via a third party, such as a signal repeater (not shown) or another remote vehicle (not shown). A vehicle 2100/2110 may transmit one or more automated inter-vehicle messages periodically, based on, for example, a defined interval, such as 100 milliseconds.

Automated inter-vehicle messages may include vehicle identification information, geospatial state information, such as longitude, latitude, or elevation information, geospatial location accuracy information, kinematic state information, such as vehicle acceleration information, yaw rate information, speed information, vehicle heading information, braking system status information, throttle information, steering wheel angle information, or vehicle routing information, or vehicle operating state information, such as vehicle size information, headlight state information, turn signal information, wiper status information, transmission information, or any other information, or combination of information, relevant to the transmitting vehicle state. For example, transmission state information may indicate whether the transmission of the transmitting vehicle is in a neutral state, a parked state, a forward state, or a reverse state.

The vehicle 2100 may communicate with the communications network 2300 via an access point 2330. The access point 2330, which may include a computing device, is configured to communicate with a vehicle 2100, with a communication network 2300, with one or more communication devices 2400, or with a combination thereof via wired or wireless communication links 2310/2340. For example, the access point 2330 may be a base station, a base transceiver station (BTS), a Node-B, an enhanced Node-B (eNode-B), a Home Node-B (HNode-B), a wireless router, a wired router, a hub, a relay, a switch, or any similar wired or wireless device. Although shown as a single unit here, an access point may include any number of interconnected elements.

The vehicle 2100 may communicate with the communications network 2300 via a satellite 2350, or other non-terrestrial communication device. The satellite 2350, which may include a computing device, is configured to communicate with a vehicle 2100, with a communication network 2300, with one or more communication devices 2400, or with a combination thereof via one or more communication links 2320/2360. Although shown as a single unit here, a satellite may include any number of interconnected elements.

An electronic communication network 2300 is any type of network configured to provide for voice, data, or any other type of electronic communication. For example, the electronic communication network 2300 may include a local area network (LAN), a wide area network (WAN), a virtual private network (VPN), a mobile or cellular telephone network, the Internet, or any other electronic communication system. The electronic communication network 2300 uses a communication protocol, such as the transmission control protocol (TCP), the user datagram protocol (UDP), the internet protocol (IP), the real-time transport protocol (RTP) the HyperText Transport Protocol (HTTP), or a combination thereof. Although shown as a single unit here, an electronic communication network may include any number of interconnected elements.

The vehicle 2100 may identify a portion or condition of the vehicle transportation network 2200. For example, the vehicle includes at least one on-vehicle sensor 2105, like the sensors 1360 shown in FIG. 1, which may be or include a speed sensor, a wheel speed sensor, a camera, a gyroscope, an optical sensor, a laser sensor, a radar sensor, a sonic sensor, or any other sensor or device or combination thereof capable of determining or identifying a portion or condition of the vehicle transportation network 2200. The sensor data may include lane line data, remote vehicle location data, or both.

The vehicle 2100 may traverse a portion or portions of the vehicle transportation network 2200 using information communicated via the network 2300, such as information representing the vehicle transportation network 2200, information identified by one or more on-vehicle sensors 2105, or a combination thereof.

Although FIG. 2 shows one vehicle transportation network 2200, one electronic communication network 2300, and one communication device 2400, for simplicity, any number of networks or communication devices may be used. The vehicle transportation and communication system 2000 may include devices, units, or elements not shown in FIG. 2. Although the vehicle 2100 is shown as a single unit, a vehicle may include any number of interconnected elements.

Although the vehicle 2100 is shown communicating with the communication device 2400 via the network 2300, the vehicle 2100 may communicate with the communication device 2400 via any number of direct or indirect communication links. For example, the vehicle 2100 may communicate with the communication device 2400 via a direct communication link, such as a Bluetooth communication link.

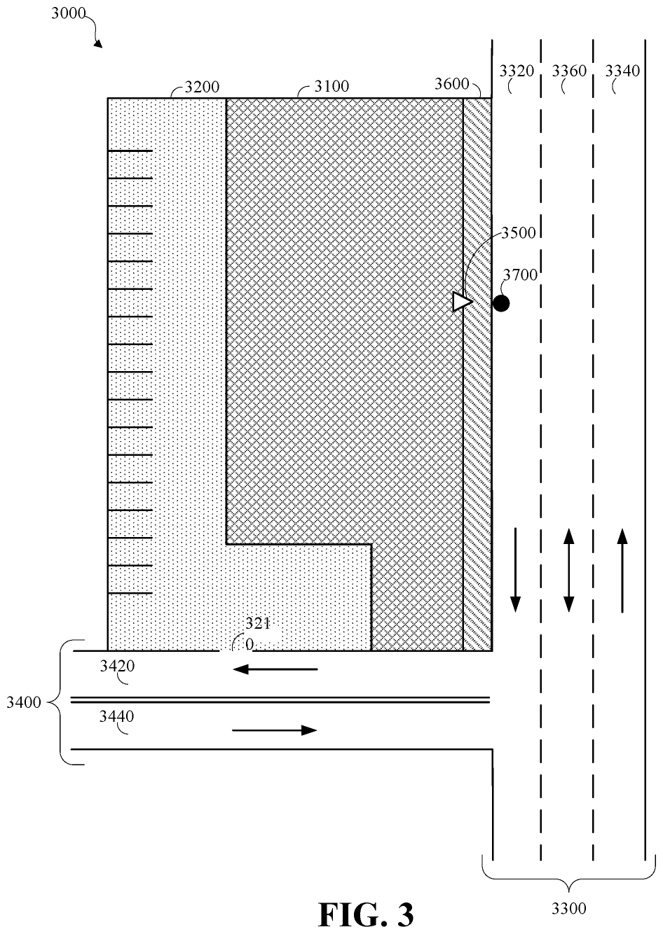

FIG. 3 is a diagram of a portion of a vehicle transportation network in accordance with this disclosure. A vehicle transportation network 3000 may include one or more unnavigable areas 3100, such as a building, one or more partially navigable areas, such as parking area 3200, one or more navigable areas, such as roads 3300/3400, or a combination thereof. In some embodiments, an autonomous vehicle, such as the vehicle 1000 shown in FIG. 1, one of the vehicles 2100/2110 shown in FIG. 2, a semi-autonomous vehicle, or any other vehicle implementing autonomous driving, may traverse a portion or portions of the vehicle transportation network 3000.

The vehicle transportation network 3000 may include one or more interchanges 3210 between one or more navigable, or partially navigable, areas 3200/3300/3400. For example, the portion of the vehicle transportation network 300 shown in FIG. 3 includes an interchange 3210 between the parking area 3200 and road 3400. A portion of the vehicle transportation network 3000, such as a road 3300/3400, may include one or more lanes 3320/3340/3360/3420/3440 and may be associated with one or more directions of travel, which are indicated by arrows in FIG. 3.

A vehicle transportation network, or a portion thereof, such as the portion of the vehicle transportation network 3000 shown in FIG. 3, may be represented as vehicle transportation network information. For example, vehicle transportation network information may be expressed as a hierarchy of elements, such as markup language elements, which may be stored in a database or file. For simplicity, the figures herein depict vehicle transportation network information representing portions of a vehicle transportation network as diagrams or maps; however, vehicle transportation network information may be expressed in any computer-usable form capable of representing a vehicle transportation network, or a portion thereof. In some embodiments, the vehicle transportation network information may include vehicle transportation network control information, such as direction of travel information, speed limit information, toll information, grade information, such as inclination or angle information, surface material information, aesthetic information or a combination thereof.

The vehicle transportation network may be associated with, or may include, a pedestrian transportation network. For example, FIG. 3 includes a portion 3600 of a pedestrian transportation network, which may be a pedestrian walkway. Although not shown separately in FIG. 3, a pedestrian navigable area, such as a pedestrian crosswalk, may correspond with a navigable area, or a partially navigable area, of a vehicle transportation network.

In some embodiments, a portion, or a combination of portions, of the vehicle transportation network may be identified as a point of interest or a destination. For example, the vehicle transportation network information may identify a building, such as the unnavigable area 3100, and the adjacent partially navigable parking area 3200 as a point of interest, a vehicle may identify the point of interest as a destination, and the vehicle may travel from an origin to the destination by traversing the vehicle transportation network. Although the parking area 3200 associated with the unnavigable area 3100 is shown as adjacent to the unnavigable area 3100 in FIG. 3, a destination may include, for example, a building and a parking area that is physically or geospatially non-adjacent to the building.

Traversing a portion of the vehicle transportation network may proceed from a topological location estimate of the vehicle to a destination. The destination may be a discrete uniquely identifiable geolocation. For example, the vehicle transportation network may include a defined location, such as a street address, a postal address, a vehicle transportation network address, a GPS address, or a combination thereof for the destination. A destination may be associated with one or more entrances, such as the entrance 3500 shown in FIG. 3.

A destination may be associated with one or more docking locations, such as the docking location 3700 shown in FIG. 3. A docking location 3700 may be a designated or undesignated location or area in proximity to a destination at which a vehicle may stop, stand, or park such that docking operations, such as passenger loading or unloading, may be performed. The vehicle transportation network information may include docking location information, such as information identifying a geolocation of the docking location 3700. Although not shown separately in FIG. 3, docking location information may identify a type of docking operation associated with a docking location 3700. For example, a destination may be associated with a first docking location for passenger loading and a second docking location for passenger unloading.

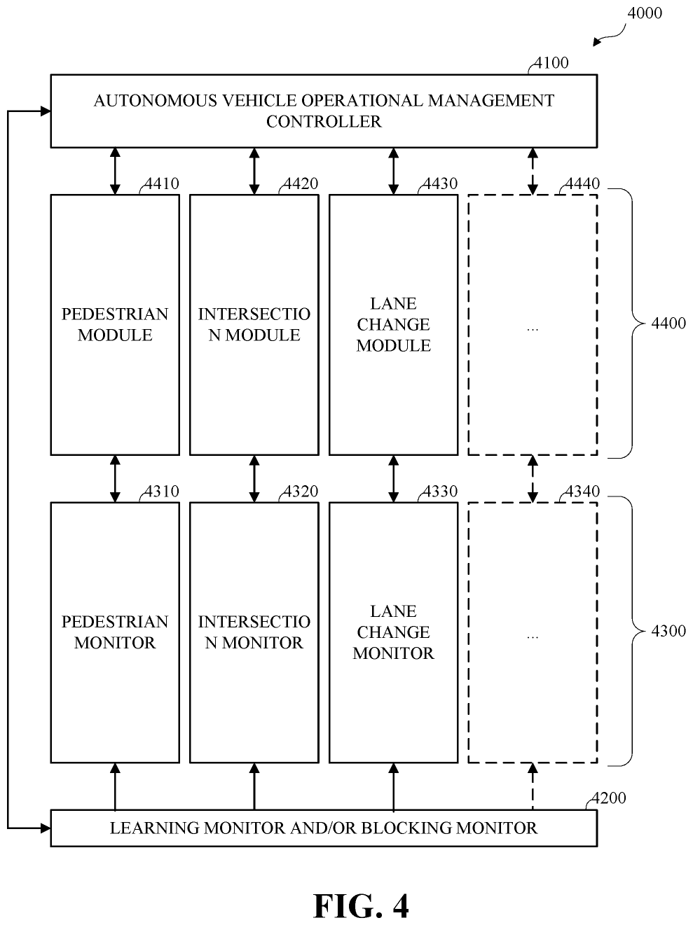

FIG. 4 is a flow diagram of an example of an autonomous vehicle operational management system 4000 configured for learning in accordance with embodiments of this disclosure. The autonomous vehicle operational management system 4000 may be implemented in an autonomous vehicle, such as the vehicle 1000 shown in FIG. 1, one of the vehicles 2100/2110 shown in FIG. 2, a semi-autonomous vehicle, or any other vehicle implementing autonomous driving.

An autonomous vehicle may traverse a vehicle transportation network, or a portion thereof, which may include traversing distinct vehicle operational scenarios. A distinct vehicle operational scenario may include any distinctly identifiable set of operative conditions that affect the operation of the autonomous vehicle within a defined spatiotemporal area, or operational environment, of the autonomous vehicle. For example, a distinct vehicle operational scenario may be based on a number or cardinality of roads, road segments, or lanes that the autonomous vehicle may traverse within a defined spatiotemporal distance. In another example, a distinct vehicle operational scenario may be based on one or more traffic control devices that may affect the operation of the autonomous vehicle within a defined spatiotemporal area, or operational environment, of the autonomous vehicle. In another example, a distinct vehicle operational scenario may be based on one or more identifiable rules, regulations, or laws that may affect the operation of the autonomous vehicle within a defined spatiotemporal area, or operational environment, of the autonomous vehicle. In another example, a distinct vehicle operational scenario may be based on one or more identifiable external objects that may affect the operation of the autonomous vehicle within a defined spatiotemporal area, or operational environment, of the autonomous vehicle.

Examples of distinct vehicle operational scenarios including a distinct vehicle operational scenario wherein the autonomous vehicle is traversing an intersection; a distinct vehicle operational scenario wherein a pedestrian is crossing, or approaching, the expected path of the autonomous vehicle; and a distinct vehicle operational scenario wherein the autonomous vehicle is changing lanes.

For simplicity and clarity, similar vehicle operational scenarios may be described herein with reference to vehicle operational scenario types or classes. For example, vehicle operational scenarios including pedestrians may be referred to herein as pedestrian scenarios referring to the types or classes of vehicle operational scenarios that include pedestrians. As an example, a first pedestrian vehicle operational scenario may include a pedestrian crossing a road at a crosswalk and as second pedestrian vehicle operational scenario may include a pedestrian crossing a road by jaywalking. Although pedestrian vehicle operational scenarios, intersection vehicle operational scenarios, and lane change vehicle operational scenarios are described herein, any other vehicle operational scenario or vehicle operational scenario type may be used.

Aspects of the operational environment of the autonomous vehicle may be represented within respective distinct vehicle operational scenarios. For example, the relative orientation, trajectory, expected path, of external objects may be represented within respective distinct vehicle operational scenarios. In another example, the relative geometry of the vehicle transportation network may be represented within respective distinct vehicle operational scenarios.

As an example, a first distinct vehicle operational scenario may correspond to a pedestrian crossing a road at a crosswalk, and a relative orientation and expected path of the pedestrian, such as crossing from left to right for crossing from right to left, may be represented within the first distinct vehicle operational scenario. A second distinct vehicle operational scenario may correspond to a pedestrian crossing a road by jaywalking, and a relative orientation and expected path of the pedestrian, such as crossing from left to right for crossing from right to left, may be represented within the second distinct vehicle operational scenario.

An autonomous vehicle may traverse multiple distinct vehicle operational scenarios within an operational environment, which may be aspects of a compound vehicle operational scenario. For example, a pedestrian may approach the expected path for the autonomous vehicle traversing an intersection.

The autonomous vehicle operational management system 4000 may operate or control the autonomous vehicle to traverse the distinct vehicle operational scenarios subject to defined constraints, such as safety constraints, legal constraints, physical constraints, user acceptability constraints, or any other constraint or combination of constraints that may be defined or derived for the operation of the autonomous vehicle.

Controlling the autonomous vehicle to traverse the distinct vehicle operational scenarios may include identifying or detecting the distinct vehicle operational scenarios, identifying candidate vehicle control actions based on the distinct vehicle operational scenarios, controlling the autonomous vehicle to traverse a portion of the vehicle transportation network in accordance with one or more of the candidate vehicle control actions, or a combination thereof.

A vehicle control action may indicate a vehicle control operation or maneuver, such as accelerating, decelerating, turning, stopping, or any other vehicle operation or combination of vehicle operations that may be performed by the autonomous vehicle in conjunction with traversing a portion of the vehicle transportation network.

The autonomous vehicle operational management controller 4100, or another unit of the autonomous vehicle, may control the autonomous vehicle to traverse the vehicle transportation network, or a portion thereof, in accordance with a vehicle control action.

For example, the autonomous vehicle operational management controller 4100 may control the autonomous vehicle to traverse the vehicle transportation network, or a portion thereof, in accordance with a ‘stop’ vehicle control action by stopping the autonomous vehicle or otherwise controlling the autonomous vehicle to become or remain stationary. Other vehicle control actions may include an ‘advance’ vehicle control action (e.g., the autonomous vehicle moves a short distance slowly), an ‘accelerate’ vehicle control action, a ‘decelerate’ vehicle control action, a ‘maintain’ vehicle control action (e.g., the autonomous vehicle maintains its speed), a ‘turn’ vehicle control action (which may include an angle of a turn), or any other standard vehicle operations. A vehicle control action may be a compound vehicle control action, which may include a sequence, combination, or both of vehicle control actions. For example, an ‘advance’ vehicle control action may indicate a ‘stop’ vehicle control action, a subsequent ‘accelerate’ vehicle control action associated with a defined acceleration rate, and a subsequent ‘stop’ vehicle control action associated with a defined deceleration rate, such that controlling the autonomous vehicle in accordance with the ‘advance’ vehicle control action includes controlling the autonomous vehicle to slowly inch forward a short distance, such as a few inches or a foot.

In another example, the autonomous vehicle operational management controller 4100 may control the autonomous vehicle to traverse the vehicle transportation network, or a portion thereof, in accordance with a ‘proceed’ vehicle control action by controlling the autonomous vehicle to traverse the vehicle transportation network, or a portion thereof, by beginning or resuming a previously identified set of operational parameters, which may include controlling the autonomous vehicle to traverse the vehicle transportation network, or a portion thereof, in accordance with one or more other vehicle control actions. For example, the autonomous vehicle may be stationary at an intersection, an identified route for the autonomous vehicle may include traversing through the intersection, and controlling the autonomous vehicle in accordance with a ‘proceed’ vehicle control action may include controlling the autonomous vehicle to accelerate at a defined acceleration rate to a defined velocity along the identified path. In another example, the autonomous vehicle may be traversing a portion of the vehicle transportation network at a defined velocity, a lane change may be identified for the autonomous vehicle, and controlling the autonomous vehicle in accordance with a ‘proceed’ vehicle control action may include controlling the autonomous vehicle to perform a sequence of trajectory adjustments in accordance with defined lane change parameters such that the autonomous vehicle performs the identified lane change operation.

A vehicle control action may include one or more performance metrics. For example, a ‘stop’ vehicle control action may include a deceleration rate as a performance metric. In another example, a ‘proceed’ vehicle control action may expressly indicate route or path information, speed information, an acceleration rate, or a combination thereof as performance metrics, or may expressly or implicitly indicate that a current or previously identified path, speed, acceleration rate, or a combination thereof may be maintained.

A vehicle control action may be a compound vehicle control action, which may include a sequence, combination, or both of vehicle control actions. For example, an ‘advance’ vehicle control action may indicate a ‘stop’ vehicle control action, a subsequent ‘accelerate’ vehicle control action associated with a defined acceleration rate, and a subsequent ‘stop’ vehicle control action associated with a defined deceleration rate, such that controlling the autonomous vehicle in accordance with the ‘advance’ vehicle control action includes controlling the autonomous vehicle to slowly inch forward a short distance, such as a few inches or a foot.

The autonomous vehicle operational management system 4000 may include an autonomous vehicle operational management controller 4100, a learning monitor 4200, operational environment monitors 4300, scenario-specific operation control evaluation modules (SSOCEMs) 4400, or a combination thereof. Although described separately, the learning monitor 4200 may be an instance, or instances, of an operational environment monitor 4300.

The autonomous vehicle operational management controller 4100 may receive, identify, or otherwise access, operational environment information representing an operational environment for the autonomous vehicle, such as a current operational environment or an expected operational environment, or one or more aspects thereof. The operational environment of the autonomous vehicle may include a distinctly identifiable set of operative conditions that may affect the operation of the autonomous vehicle within a defined spatiotemporal area of the autonomous vehicle. For example, the operational environment information may include vehicle information for the autonomous vehicle, such as information indicating a geospatial location of the autonomous vehicle, information correlating the geospatial location of the autonomous vehicle to information representing the vehicle transportation network, a route of the autonomous vehicle, a speed of the autonomous vehicle, an acceleration state of the autonomous vehicle, passenger information of the autonomous vehicle, or any other information about the autonomous vehicle or the operation of the autonomous vehicle. In another example, the operational environment information may include information representing the vehicle transportation network proximate to the autonomous vehicle, such as within a defined spatial distance of the autonomous vehicle, such as 300 meters, information indicating the geometry of one or more aspects of the vehicle transportation network, information indicating a condition, such as a surface condition, of the vehicle transportation network, or any combination thereof. In another example, the operational environment information may include information representing external objects within the operational environment of the autonomous vehicle, such as information representing pedestrians, non-human animals, non-motorized transportation devices, such as bicycles or skateboards, motorized transportation devices, such as remote vehicles, or any other external object or entity that may affect the operation of the autonomous vehicle.

The autonomous vehicle operational management controller 4100 may monitor the operational environment of the autonomous vehicle, or defined aspects thereof. Monitoring the operational environment of the autonomous vehicle may include identifying and tracking external objects, identifying distinct vehicle operational scenarios, or a combination thereof. For example, the autonomous vehicle operational management controller 4100 may identify and track external objects with the operational environment of the autonomous vehicle. Identifying and tracking the external objects may include identifying spatiotemporal locations of respective external objects, which may be relative to the autonomous vehicle, identifying one or more expected paths for respective external objects, which may include identifying a speed, a trajectory, or both, for an external object. For simplicity and clarity, descriptions of locations, expected locations, paths, expected paths, and the like herein may omit express indications that the corresponding locations and paths refer to geospatial and temporal components; however, unless expressly indicated herein, or otherwise unambiguously clear from context, the locations, expected locations, paths, expected paths, and the like described herein may include geospatial components, temporal components, or both.

The operational environment monitors 4300 may include an operational environment monitor 4310 for monitoring pedestrians (pedestrian monitor), an operational environment monitor 4320 for monitoring intersections (intersection monitor), an operational environment monitor 4330 for monitoring lane changes (lane change monitor), or a combination thereof. An operational environment monitor 4340 is shown using broken lines to indicate that the autonomous vehicle operational management system 4000 may include any number of operational environment monitors 4300.

One or more distinct vehicle operational scenarios may be monitored by a respective operational environment monitor 4300. For example, the pedestrian monitor 4310 may monitor operational environment information corresponding to multiple pedestrian vehicle operational scenarios, the intersection monitor 4320 may monitor operational environment information corresponding to multiple intersection vehicle operational scenarios, and the lane change monitor 4330 may monitor operational environment information corresponding to multiple lane change vehicle operational scenarios. An operational environment monitor 4300 may receive, or otherwise access, operational environment information, such as operational environment information generated or captured by one or more sensors of the autonomous vehicle, vehicle transportation network information, vehicle transportation network geometry information, or a combination thereof. For example, the operational environment monitor 4310 for monitoring pedestrians may receive, or otherwise access, information, such as sensor information, which may indicate, correspond to, or may otherwise be associated with, one or more pedestrians in the operational environment of the autonomous vehicle.

An operational environment monitor 4300 may associate the operational environment information, or a portion thereof, with the operational environment, or an aspect thereof, such as with an external object, such as a pedestrian, a remote vehicle, or an aspect of the vehicle transportation network geometry. An operational environment monitor 4300 may generate, or otherwise identify, information representing one or more aspects of the operational environment, such as with an external object, such as a pedestrian, a remote vehicle, or an aspect of the vehicle transportation network geometry, which may include filtering, abstracting, or otherwise processing the operational environment information. An operational environment monitor 4300 may output the information representing the one or more aspects of the operational environment to, or for access by, the autonomous vehicle operational management controller 4100, such by storing the information representing the one or more aspects of the operational environment in a memory, such as the memory 1340 shown in FIG. 1, of the autonomous vehicle accessible by the autonomous vehicle operational management controller 4100, sending the information representing the one or more aspects of the operational environment to the autonomous vehicle operational management controller 4100, or a combination thereof. An operational environment monitor 4300 may output the information representing the one or more aspects of the operational environment to one or more elements of the autonomous vehicle operational management system 4000, such as the learning monitor 4200.

The pedestrian operational environment monitor 4310 may correlate, associate, or otherwise process the operational environment information to identify, track, or predict actions of one or more pedestrians. For example, the pedestrian operational environment monitor 4310 may receive information, such as sensor information, from one or more sensors, that may correspond to one or more pedestrians, the pedestrian operational environment monitor 4310 may associate the sensor information with one or more identified pedestrians, which may include identifying a direction of travel, a path, such as an expected path, a current or expected velocity, a current or expected acceleration rate, or a combination thereof for one or more of the respective identified pedestrians, and the pedestrian operational environment monitor 4310 may output the identified, associated, or generated pedestrian information to, or for access by, the autonomous vehicle operational management controller 4100.

In another example, the intersection operational environment monitor 4320 may correlate, associate, or otherwise process the operational environment information to identify, track, or predict actions of one or more remote vehicles in the operational environment of the autonomous vehicle, to identify an intersection, or an aspect thereof, in the operational environment of the autonomous vehicle, to identify vehicle transportation network geometry, or a combination thereof. For example, the intersection operational environment monitor 4310 may receive information, such as sensor information, from one or more sensors, that may correspond to one or more remote vehicles in the operational environment of the autonomous vehicle, the intersection, or one or more aspects thereof, in the operational environment of the autonomous vehicle, the vehicle transportation network geometry, or a combination thereof, the intersection operational environment monitor 4310 may associate the sensor information with one or more identified remote vehicles in the operational environment of the autonomous vehicle, the intersection, or one or more aspects thereof, in the operational environment of the autonomous vehicle, the vehicle transportation network geometry, or a combination thereof, which may include may identifying a current or expected direction of travel, a path, such as an expected path, a current or expected velocity, a current or expected acceleration rate, or a combination thereof for one or more of the respective identified remote vehicles, and the intersection operational environment monitor 4320 may output the identified, associated, or generated intersection information to, or for access by, the autonomous vehicle operational management controller 4100.

In another example, the lane change operational environment monitor 4330 may correlate, associate, or otherwise process the operational environment information to identify, track, or predict actions of one or more remote vehicles in the operational environment of the autonomous vehicle, such as information indicating a slow or stationary remote vehicle along the expected path of the autonomous vehicle, to identify one or more aspects of the operational environment of the autonomous vehicle, such as vehicle transportation network geometry in the operational environment of the autonomous vehicle, or a combination thereof geospatially corresponding to a current or expected lane change operation. For example, the lane change operational environment monitor 4330 may receive information, such as sensor information, from one or more sensors, that may correspond to one or more remote vehicles in the operational environment of the autonomous vehicle, one or more aspects of the operational environment of the autonomous vehicle in the operational environment of the autonomous vehicle or a combination thereof geospatially corresponding to a current or expected lane change operation, the lane change operational environment monitor 4330 may associate the sensor information with one or more identified remote vehicles in the operational environment of the autonomous vehicle, one or more aspects of the operational environment of the autonomous vehicle or a combination thereof geospatially corresponding to a current or expected lane change operation, which may include may identifying a current or expected direction of travel, a path, such as an expected path, a current or expected velocity, a current or expected acceleration rate, or a combination thereof for one or more of the respective identified remote vehicles, and the lane change operational environment monitor 4330 may output the identified, associated, or generated lane change information to, or for access by, the autonomous vehicle operational management controller 4100.

The autonomous vehicle operational management controller 4100 may identify one or more distinct vehicle operational scenarios based on one or more aspects of the operational environment represented by the operational environment information. For example, the autonomous vehicle operational management controller 4100 may identify a distinct vehicle operational scenario in response to identifying, or based on, the operational environment information indicated by one or more of the operational environment monitors 4300.

The autonomous vehicle operational management controller 4100 may identify multiple distinct vehicle operational scenarios based on one or more aspects of the operational environment represented by the operational environment information. For example, the operational environment information may include information representing a pedestrian approaching an intersection along an expected path for the autonomous vehicle, and the autonomous vehicle operational management controller 4100 may identify a pedestrian vehicle operational scenario, an intersection vehicle operational scenario, or both.

The autonomous vehicle operational management controller 4100 may instantiate respective instances of one or more of the scenario-specific operational control evaluation modules 4400 based on one or more aspects of the operational environment represented by the operational environment information. For example, the autonomous vehicle operational management controller 4100 may instantiate the instance of the scenario-specific operational control evaluation module 4400 in response to identifying the distinct vehicle operational scenario.

The autonomous vehicle operational management controller 4100 may instantiate multiple instances of one or more scenario-specific operational control evaluation modules 4400 (SSOCEM 4400) based on one or more aspects of the operational environment represented by the operational environment information. For example, the autonomous vehicle operational management controller 4100 may instantiate the instance of the scenario-specific operational control evaluation module 4400 in response to identifying the distinct vehicle operational scenario. A SSOCEM 4400, once instantiated, can receive operational environment information, including sensor data, to output a candidate vehicle control action. A candidate vehicle control action is a vehicle control action that is identified by the particular SSOCEM 4400 as the likely optimal action for the vehicle to perform to handle a particular scenario. For instance, a SSOCEM 4400 configured to handle intersections (e.g., an intersection module 4420) may output a “proceed” candidate vehicle control action that suggests proceeding through an intersection. At the same time, a SSOCEM 4400 for handling lane changes (e.g., the lane change module 4430) may output a “turn left” candidate vehicle control action indicating that the autonomous vehicle should merge left by two degrees. In some implementations, each SSOCEM 4400 outputs a confidence score indicating a degree of confidence in the candidate vehicle control action determined by the SSOCEM. For instance, a confidence score greater than 0.95 may indicate a very high confidence in the candidate vehicle control action, while a confidence score less than 0.5 may indicate a relatively low degree of confidence in the candidate vehicle control action.

The autonomous vehicle operational management controller 4100 receives the candidate vehicle control actions and determines a vehicle control action based on the candidate vehicle control actions. In some implementations, the autonomous vehicle operational management controller 4100 utilizes hard coded rules to determine the vehicle control action. For example, the autonomous vehicle operational management controller 4100 may select the candidate vehicle control action having the highest confidence score. In other implementations, the autonomous vehicle operational management controller 4100 may select the candidate vehicle control action that is the least likely to result in a collision. In other implementations, the autonomous vehicle operational management controller 4100 may generate a compound action based on two or more non-conflicting candidate vehicle control actions (e.g., compounding “proceed” and “turn left by two degrees” to result in a vehicle control action that causes the vehicle to veer left and proceed through an intersection). In some implementations, the autonomous vehicle operational management controller 4100 may utilize a machine learning algorithm to determine a vehicle control action based on two or more differing candidate vehicle control actions.

A scenario-specific operational control evaluation module 4400 may include one or more models that are configured to determine one or more vehicle control actions for handling a scenario given a set of inputs. The models may include, but are not limited to, Partially Observable Markov Decision Process (POMDP), Markov Decision Process (MDP), artificial neural networks, hard-coded expert logic, or any other suitable types of models. Each scenario-specific operational control evaluation module 4100 may further include computer-executable instructions for determining whether to utilize the model. Each scenario-specific operational control evaluation module includes computer-executable instructions that define a manner by which the models operate and a manner by which the models are utilized.

The operational environment information may indicate two pedestrians in the operational environment of the autonomous vehicle and the autonomous vehicle operational management controller 4100 may instantiate a respective instance of the pedestrian-scenario-specific operational control evaluation module 4410 for each pedestrian based on one or more aspects of the operational environment represented by the operational environment information.

The cardinality, number, or count, of identified external objects, such as pedestrians or remote vehicles, corresponding to a scenario, such as the pedestrian scenario, the intersection scenario, or the lane change scenario, may exceed a defined threshold, which may be a defined scenario-specific threshold, and the autonomous vehicle operational management controller 4100 may omit instantiating an instance of a scenario-specific operational control evaluation module 4400 corresponding to one or more of the identified external objects.

For example, the operational environment information indicated by the operational environment monitors 4300 may indicate twenty-five pedestrians in the operational environment of the autonomous vehicle, the defined threshold for the pedestrian scenario may be a defined cardinality, such as ten, of pedestrians, the autonomous vehicle operational management controller 4100 may identify the ten most relevant pedestrians, such as the ten pedestrians geospatially most proximate to the autonomous vehicle having converging expected paths with the autonomous vehicle, the autonomous vehicle operational management controller 4100 may instantiate ten instances of the pedestrian-scenario-specific operational control evaluation module 4410 for the ten most relevant pedestrians, and the autonomous vehicle operational management controller 4100 may omit instantiating instances of the pedestrian-scenario-specific operational control evaluation module 4410 for the fifteen other pedestrians.

In another example, the operational environment information indicated by the operational environment monitors 4300 may indicate an intersection including four road segments, such as a northbound road segment, a southbound road segment, an eastbound road segment, and a westbound road segment, and indicating five remote vehicles corresponding to the northbound road segment, three remote vehicles corresponding to the southbound road segment, four remote vehicles corresponding to the eastbound road segment, and two remote vehicles corresponding to the westbound road segment, the defined threshold for the intersection scenario may be a defined cardinality, such as two, of remote vehicles per road segment, the autonomous vehicle operational management controller 4100 may identify the two most relevant remote vehicles per road segment, such as the two remote vehicles geospatially most proximate to the intersection having converging expected paths with the autonomous vehicle per road segment, the autonomous vehicle operational management controller 4100 may instantiate two instances of the intersection-scenario-specific operational control evaluation module 4420 for the two most relevant remote vehicles corresponding to the northbound road segment, two instances of the intersection-scenario-specific operational control evaluation module 4420 for the two most relevant remote vehicles corresponding to the southbound road segment, two instances of the intersection-scenario-specific operational control evaluation module 4420 for the two most relevant remote vehicles corresponding to the eastbound road segment, and two instances of the intersection-scenario-specific operational control evaluation module 4420 for the two remote vehicles corresponding to the westbound road segment, and the autonomous vehicle operational management controller 4100 may omit instantiating instances of the intersection-scenario-specific operational control evaluation module 4420 for the three other remote vehicles corresponding to the northbound road segment, the other remote vehicle corresponding to the southbound road segment, and the two other remote vehicles corresponding to the eastbound road segment. Alternatively, or in addition, the defined threshold for the intersection scenario may be a defined cardinality, such as eight, remote vehicles per intersection, and the autonomous vehicle operational management controller 4100 may identify the eight most relevant remote vehicles for the intersection, such as the eight remote vehicles geospatially most proximate to the intersection having converging expected paths with the autonomous vehicle, the autonomous vehicle operational management controller 4100 may instantiate eight instances of the intersection-scenario-specific operational control evaluation module 4420 for the eight most relevant remote vehicles, and the autonomous vehicle operational management controller 4100 may omit instantiating instances of the intersection-scenario-specific operational control evaluation module 4420 for the six other remote vehicles.

The autonomous vehicle operational management controller 4100 may send the operational environment information, or one or more aspects thereof, to another unit of the autonomous vehicle, such as the learning monitor 4200 or one or more instances of the SSOCEM 4400.

The autonomous vehicle operational management controller 4100 may store the operational environment information, or one or more aspects thereof, such as in a memory, such as the memory 1340 shown in FIG. 1, of the autonomous vehicle.

The autonomous vehicle operational management controller 4100 may receive candidate vehicle control actions from respective instances of the SSOCEM 4400. For example, a candidate vehicle control action from a first instance of a first SSOCEM 4400 may indicate a ‘stop’ vehicle control action, a candidate vehicle control action from a second instance of a second SSOCEM 4400 may indicate an ‘advance’ vehicle control action, and a candidate vehicle control action from a third instance of a third SSOCEM 4400 may indicate a ‘proceed’ vehicle control action.

The autonomous vehicle operational management controller 4100 may determine whether to traverse a portion of the vehicle transportation network in accordance with one or more candidate vehicle control actions. For example, the autonomous vehicle operational management controller 4100 may receive multiple candidate vehicle control actions from multiple instances of SSOCEM s 4400, may identify a vehicle control action from the candidate vehicle control actions, and may traverse the vehicle transportation network in accordance with the vehicle control action.

The autonomous vehicle operational management controller 4100 may identify a vehicle control action from the candidate vehicle control actions based on one or more defined vehicle control action identification metrics.

The defined vehicle control action identification metrics may include a priority, weight, or rank, associated with each type of vehicle control action, and identifying the vehicle control action from the candidate vehicle control actions may include identifying a highest priority vehicle control action from the candidate vehicle control actions. For example, the ‘stop’ vehicle control action may be associated with a high priority, the ‘advance’ vehicle control action may be associated with an intermediate priority, which may be lower than the high priority, and the ‘proceed’ vehicle control action may be associated with a low priority, which may be lower than the intermediate priority. In an example, the candidate vehicle control actions may include one or more ‘stop’ vehicle control actions, and the ‘stop’ vehicle control action may be identified as the vehicle control action. In another example, the candidate vehicle control actions may omit a ‘stop’ vehicle control action, may include one or more ‘advance’ vehicle control actions, and the ‘advance’ vehicle control action may be identified as the vehicle control action. In another example, the candidate vehicle control actions may omit a ‘stop’ vehicle control action, may omit an ‘advance’ vehicle control action, may include one or more ‘proceed’ vehicle control actions, and the ‘proceed’ vehicle control action may be identified as the vehicle control action.

Identifying the vehicle control action from the candidate vehicle control actions may include generating or calculating a weighted average for each type of vehicle control action based on the defined vehicle control action identification metrics, the instantiated scenarios, weights associated with the instantiated scenarios, the candidate vehicle control actions, weights associated with the candidate vehicle control actions, or a combination thereof.

For example, identifying the vehicle control action from the candidate vehicle control actions may include implementing a machine learning component, such as supervised learning of a classification problem, and training the machine learning component using examples, such as 1000 examples, of the corresponding vehicle operational scenario. In another example, identifying the vehicle control action from the candidate vehicle control actions may include implementing an MDP or a POMDP, which may describe how respective candidate vehicle control actions affect subsequent candidate vehicle control actions affect, and may include a reward function that outputs a positive or negative reward for respective vehicle control actions.

The autonomous vehicle operational management controller 4100 may uninstantiate an instance of a scenario-specific operational control evaluation module 4400. For example, the autonomous vehicle operational management controller 4100 may identify a distinct set of operative conditions as indicating a distinct vehicle operational scenario for the autonomous vehicle, instantiate an instance of a SSOCEM 4400 for the distinct vehicle operational scenario, monitor the operative conditions, subsequently determine that one or more of the operative conditions has expired, or has a probability of affecting the operation of the autonomous vehicle below a defined threshold, and the autonomous vehicle operational management controller 4100 may uninstantiate the instance of the SSOCEM 4400.

The learning monitor 4200 may receive operational environment information representing an operational environment, or an aspect thereof, for the autonomous vehicle. For example, the learning monitor 4200 may receive the operational environment information from the autonomous vehicle operational management controller 4100, from a sensor of the autonomous vehicle, from an external device, such as a remote vehicle or an infrastructure device, or a combination thereof. In some embodiments, the learning monitor 4200 may read the operational environment information, or a portion thereof, from a memory, such as a memory of the autonomous vehicle, such as the memory 1340 shown in FIG. 1.

Although not expressly shown in FIG. 4, the autonomous vehicle operational management system 4000 may include a predictor module that may generate and send prediction information to the learning monitor 4200, and the learning monitor 4200 may output probability of a vehicle control action based on a stored observation of the operational environment.

The learning monitor 4200 may determine a respective probability of a vehicle control action, for one or more portions of the vehicle transportation network, such as portions of the vehicle transportation network proximal to the autonomous vehicle, which may include portions of the vehicle transportation network corresponding to an expected path of the autonomous vehicle, such as an expected path identified based on a current route of the autonomous vehicle.

A probability of a vehicle control action may indicate a probability or likelihood that the autonomous vehicle may traverse a portion of, or spatial location within, the vehicle transportation network safely, such as unimpeded by an external object, such as a remote vehicle or a pedestrian. For example, a portion of the vehicle transportation network may include an obstruction, such as a stationary object, and a probability of traversal via the obstructed portion of the vehicle transportation network may be low, such as 0%. The learning monitor 4200 may identify a respective probability of traversal for each of multiple portions of the vehicle transportation network within an operational environment, such as within 300 meters of the autonomous vehicle.

The learning monitor 4200 may identify a portion of the vehicle transportation network and a corresponding probability of traversal based on operating information for the autonomous vehicle, operating information for one or more external objects, vehicle transportation network information representing the vehicle transportation network, or a combination thereof. The operating information for the autonomous vehicle may include information indicating a geospatial location of the autonomous vehicle in the vehicle transportation network, which may be a current location or an expected location, such as an expected location identified based on an expected path for the autonomous vehicle. The operating information for the external objects may indicate a respective geospatial location of one or more external objects in, or proximate to, the vehicle transportation network, which may be a current location or an expected location, such as an expected location identified based on an expected path for the respective external object.

A probability of traversal may be indicated by the blocking monitor 4200 corresponding to each external object in the operational environment of the autonomous vehicle and a geospatial area may be associated with multiple probabilities of traversal corresponding to multiple external objects. An aggregate probability of traversal may be indicated by the learning monitor 4200 corresponding to each type of external object in the operational environment of the autonomous vehicle, such as a probability of traversal for pedestrians and a probability of traversal for remote vehicles, and a geospatial area may be associated with multiple probabilities of traversal corresponding to multiple external object types. In some embodiments, the learning monitor 4200 may indicate one aggregate probability of traversal for each geospatial location, which may include multiple temporal probabilities of traversal for a geographical location.

The learning monitor 4200 may identify external objects, track external objects, project location information, path information, or both for external objects, or a combination thereof. For example, the learning monitor 4200 may identify an external object and may identify an expected path for the external object, which may indicate a sequence of expected spatial locations, expected temporal locations, and corresponding probabilities.

The learning monitor 4200 may identify the expected path for an external object based on operational environment information, such as information indicating a current location of the external object, information indicating a current trajectory for the external object, information indicating a type of classification of the external object, such as information classifying the external object as a pedestrian or a remote vehicle, vehicle transportation network information, such as information indicating that the vehicle transportation network includes a crosswalk proximate to the external object, previously identified or tracked information associated with the external object, or any combination thereof. For example, the external object may be identified as a remote vehicle, and the expected path for the remote vehicle may be identified based on information indicating a current location of the remote vehicle, information indicating a current trajectory of the remote vehicle, information indicating a current speed of the remote vehicle, vehicle transportation network information corresponding to the remote vehicle, legal or regulatory information, or a combination thereof.

The learning monitor 4200 may receive the expected path for an external object based on operational environment information, such as information indicating a current location of the external object, information indicating a current trajectory for the external object, information indicating a type of classification of the external object, such as information classifying the external object as a pedestrian or a remote vehicle, vehicle transportation network information, such as information indicating that the vehicle transportation network includes a crosswalk proximate to the external object, previously identified or tracked information associated with the external object, or any combination thereof. For example, the external object may a remote vehicle, and the expected path for the remote vehicle may be received based on information indicating a current location of the remote vehicle, information indicating a current trajectory of the remote vehicle, information indicating a current speed of the remote vehicle, vehicle transportation network information corresponding to the remote vehicle, legal or regulatory information, or a combination thereof.

The learning monitor 4200 may determine, or update, probabilities of traversal continually or periodically. One or more classes or types of external object may be identified as a preferential object, and the expected path of a preferential object may overlap, spatially and temporally, the expected path of another preferential object. For example, the expected path of a pedestrian may overlap with the expected path of another pedestrian. One or more classes or types of external object may be identified as a deferential object, and the expected path of a deferential object may be blocked, such as impeded or otherwise affected, by other external objects. For example, the expected path for a remote vehicle may be blocked by another remote vehicle or by a pedestrian.

The learning monitor 4200 may identify expected paths for preferential objects, such as pedestrians, and may identify expected paths for deferential objects, such as remote vehicles, subject to the expected paths for the preferential objects. The learning monitor 4200 may communicate probabilities of traversal to the autonomous vehicle operational management controller 4100. The autonomous vehicle operational management controller 4100 may communicate the probabilities of traversal to respective instantiated instances of the scenario-specific operational control evaluation modules 4400.

Each scenario-specific operational control evaluation module 4400 may model a respective distinct vehicle operational scenario. The autonomous vehicle operational management system 4000 may include any number of SSOCEMs 4400, each modeling a respective distinct vehicle operational scenario.

Modeling a distinct vehicle operational scenario, by a SSOCEM 4400, may include generating, maintaining, or both state information representing aspects of an operational environment of the autonomous vehicle corresponding to the distinct vehicle operational scenario, identifying potential interactions among the modeled aspects respective of the corresponding states, and determining a candidate vehicle control action that solves the model. In some embodiments, aspects of the operational environment of the autonomous vehicle other than the defined set of aspects of the operational environment of the autonomous vehicle corresponding to the distinct vehicle operational scenario may be omitted from the model.

The autonomous vehicle operational management system 4000 may be solution independent and may include any model of a distinct vehicle operational scenario, such as a single-agent model, a multi-agent model, a learning model, or any other model of one or more distinct vehicle operational scenarios.

One or more of the SSOCEMs 4400 may be a Classical Planning (CP) model, which may be a single-agent model, and which may model a distinct vehicle operational scenario based on a defined input state, which may indicate respective non-probabilistic states of the elements of the operational environment of the autonomous vehicle for the distinct vehicle operational scenario modeled by the scenario-specific operational control evaluation modules 4400. In a CP model, one or more aspects, such as geospatial location, of modeled elements, such as external objects, associated with a temporal location may differ from the corresponding aspects associated with another temporal location, such as an immediately subsequent temporal location, non-probabilistically, such as by a defined, or fixed, amount. For example, at a first temporal location, a remote vehicle may have a first geospatial location, and, at an immediately subsequent second temporal location the remote vehicle may have a second geospatial location that differs from the first geospatial location by a defined geospatial distance, such as a defined number of meters, along an expected path for the remote vehicle.

One or more of the SSOCEMs 4400 may be a discrete time stochastic control process, such as an MDP model, which may be a single-agent model, and which may model a distinct vehicle operational scenario based on a defined input state. Changes to the operational environment of the autonomous vehicle, such as a change of location for an external object, may be modeled as probabilistic changes. An MDP model may utilize more processing resources and may more accurately model the distinct vehicle operational scenario than a CP model.

An MDP model may model a distinct vehicle operational scenario as a sequence of temporal locations, such as a current temporal location, future temporal locations, or both, with corresponding states, such as a current state, expected future states, or both. At each temporal location the model may have a state, which may be an expected state, and which may be associated with one or more candidate vehicle control actions. The model may represent the autonomous vehicle as an agent, which may transition, along the sequence of temporal locations, from one state (a current state) to another state (subsequent state) in accordance with an identified action for the current state and a probability that the identified action will transition the state from the current state to the subsequent state.

The model may accrue a reward, which may be a positive or negative value, corresponding to transitioning from the one state to another according to a respective action. The model may solve the distinct vehicle operational scenario by identifying the actions corresponding to each state in the sequence of temporal locations that maximizes the cumulative reward. Solving a model may include identifying a vehicle control action in response to the modeled scenario and the operational environment information.

An MDP model may model a distinct vehicle operational scenario using a set of states, a set of actions, a set of state transition probabilities, a reward function, or a combination thereof. In some embodiments, modeling a distinct vehicle operational scenario may include using a discount factor, which may adjust, or discount, the output of the reward function applied to subsequent temporal periods.

The set of states may include a current state of the MDP model, one or more possible subsequent states of the MDP model, or a combination thereof. A state may represent an identified condition, which may be an expected condition, of respective defined aspects, such as external objects and traffic control devices, of the operational environment of the autonomous vehicle that may probabilistically affect the operation of the autonomous vehicle at a discrete temporal location. For example, a remote vehicle operating in the proximity of the autonomous vehicle may affect the operation of the autonomous vehicle and may be represented in an MDP model, which may include representing an identified or expected geospatial location of the remote vehicle, an identified or expected path, heading, or both of the remote vehicle, an identified or expected velocity of the remote vehicle, an identified or expected acceleration or deceleration rate of the remote vehicle, or a combination thereof corresponding to the respected temporal location. At instantiation, the current state of the MDP model may correspond to a contemporaneous state or condition of the operating environment. A respective set of states may be defined for each distinct vehicle operational scenario.

Although any number or cardinality of states may be used, the number or cardinality of states included in a model may be limited to a defined maximum number of states, such as 300 states. For example, a model may include the 300 most probable states for a corresponding scenario.

The set of actions may include vehicle control actions available to the MDP model at each state in the set of states. A respective set of actions may be defined for each distinct vehicle operational scenario.

The set of state transition probabilities may probabilistically represent potential or expected changes to the operational environment of the autonomous vehicle, as represented by the states, responsive to the actions. For example, a state transition probability may indicate a probability that the operational environment of the autonomous vehicle corresponds to a respective state at a respective temporal location immediately subsequent to a current temporal location corresponding to a current state in response to traversing the vehicle transportation network by the autonomous vehicle from the current state in accordance with a respective action.

The set of state transition probabilities may be identified based on the operational environment information. For example, the operational environment information may indicate an area type, such as urban or rural, a time of day, an ambient light level, weather conditions, traffic conditions, which may include expected traffic conditions, such as rush hour conditions, event-related traffic congestion, or holiday related driver behavior conditions, road conditions, jurisdictional conditions, such as country, state, or municipality conditions, or any other condition or combination of conditions that may affect the operation of the autonomous vehicle.

Examples of state transition probabilities associated with a pedestrian vehicle operational scenario may include a defined probability of a pedestrian jaywalking, which may be based on a geospatial distance between the pedestrian and the respective road segment; a defined probability of a pedestrian stopping in an intersection; a defined probability of a pedestrian crossing at a crosswalk; a defined probability of a pedestrian yielding to the autonomous vehicle at a crosswalk; any other probability associated with a pedestrian vehicle operational scenario.

Examples of state transition probabilities associated with an intersection vehicle operational scenario may include a defined probability of a remote vehicle arriving at an intersection; a defined probability of a remote vehicle cutting-off the autonomous vehicle; a defined probability of a remote vehicle traversing an intersection immediately subsequent to, and in close proximity to, a second remote vehicle traversing the intersection, such as in the absence of a right-of-way (piggybacking); a defined probability of a remote vehicle stopping, adjacent to the intersection, in accordance with a traffic control device, regulation, or other indication of right-of-way, prior to traversing the intersection; a defined probability of a remote vehicle traversing the intersection; a defined probability of a remote vehicle diverging from an expected path proximal to the intersection; a defined probability of a remote vehicle diverging from an expected right-of-way priority; any other probability associated with a an intersection vehicle operational scenario.

Examples of state transition probabilities associated with a lane change vehicle operational scenario may include a defined probability of a remote vehicle changing velocity, such as a defined probability of a remote vehicle behind the autonomous vehicle increasing velocity or a defined probability of a remote vehicle in front of the autonomous vehicle decreasing velocity; a defined probability of a remote vehicle in front of the autonomous vehicle changing lanes; a defined probability of a remote vehicle proximate to the autonomous vehicle changing speed to allow the autonomous vehicle to merge into a lane; or any other probabilities associated with a lane change vehicle operational scenario.

The reward function may determine a respective positive or negative (cost) value that may be accrued for each combination of state and action, which may represent an expected value of the autonomous vehicle traversing the vehicle transportation network from the corresponding state in accordance with the corresponding vehicle control action to the subsequent state.

The reward function may be identified based on the operational environment information. For example, the operational environment information may indicate an area type, such as urban or rural, a time of day, an ambient light level, weather conditions, traffic conditions, which may include expected traffic conditions, such as rush hour conditions, event-related traffic congestion, or holiday related driver behavior conditions, road conditions, jurisdictional conditions, such as country, state, or municipality conditions, or any other condition or combination of conditions that may affect the operation of the autonomous vehicle.

One or more of the SSOCEMs 4400 may be a POMDP model, which may be a single-agent model. A POMDP model may be similar to an MDP model, except that a POMDP model may include modeling uncertain states. A POMDP model may include modeling confidence, sensor trustworthiness, distraction, noise, uncertainty, such as sensor uncertainty, or the like. A POMDP model may utilize more processing resources and may more accurately model the distinct vehicle operational scenario than an MDP model.

A POMDP model may model a distinct vehicle operational scenario using a set of states, a set of states, a set of actions, a set of state transition probabilities, a reward function, a set of observations, a set of conditional observation probabilities, or a combination thereof. The set of states, the set of actions, the set of state transition probabilities, and the reward function may be similar to those described above with respect to the MDP model.

The set of observations may include observations corresponding to respective states. An observation may provide information about the attributes of a respective state. An observation may correspond with a respective temporal location. An observation may include operational environment information, such as sensor information. An observation may include expected or predicted operational environment information.

For example, a POMDP model may include an autonomous vehicle at a first geospatial location and first temporal location corresponding to a first state, the model may indicate that the autonomous vehicle may identify and perform, or attempt to perform, a vehicle control action to traverse the vehicle transportation network from the first geospatial location to a second geospatial location at a second temporal location immediately subsequent to the first temporal location, and the set of observations corresponding to the second temporal location may include the operational environment information that may be identified corresponding to the second temporal location, such as geospatial location information for the autonomous vehicle, geospatial location information for one or more external objects, probabilities of traversal, expected path information, or the like.

The set of conditional observation probabilities may include probabilities of making respective observations based on the operational environment of the autonomous vehicle. For example, an autonomous vehicle may approach an intersection by traversing a first road, contemporaneously, a remote vehicle may approach the intersection by traversing a second road, the autonomous vehicle may identify and evaluate operational environment information, such as sensor information, corresponding to the intersection, which may include operational environment information corresponding to the remote vehicle. In some embodiments, the operational environment information may be inaccurate, incomplete, or erroneous. In an MDP model, the autonomous vehicle may non-probabilistically identify the remote vehicle, which may include identifying a location of the remote vehicle, an expected path for the remote vehicle, or the like, and the identified information, such as the identified location of the remote vehicle, based on inaccurate operational environment information, may be inaccurate or erroneous. In a POMDP model the autonomous vehicle may identify information probabilistically identifying the remote vehicle, which may include probabilistically identifying location information for the remote vehicle, such as location information indicating that the remote vehicle may be proximate to the intersection. The conditional observation probability corresponding to observing, or probabilistically identifying, the location of the remote vehicle may represent the probability that the identified operational environment information accurately represents the location of the remote vehicle.

The set of conditional observation probabilities may be identified based on the operational environment information. For example, the operational environment information may indicate an area type, such as urban or rural, a time of day, an ambient light level, weather conditions, traffic conditions, which may include expected traffic conditions, such as rush hour conditions, event-related traffic congestion, or holiday related driver behavior conditions, road conditions, jurisdictional conditions, such as country, state, or municipality conditions, or any other condition or combination of conditions that may affect the operation of the autonomous vehicle.

In some embodiments, such as embodiments implementing a POMDP model, modeling an autonomous vehicle operational control scenario may include modeling occlusions. For example, the operational environment information may include information corresponding to one or more occlusions, such as sensor occlusions, in the operational environment of the autonomous vehicle such that the operational environment information may omit information representing one or more occluded external objects in the operational environment of the autonomous vehicle. For example, an occlusion may be an external object, such as a traffic signs, a building, a tree, an identified external object, or any other operational condition or combination of operational conditions capable of occluding one or more other operational conditions, such as external objects, from the autonomous vehicle at a defined spatiotemporal location. An operational environment monitor 4300 may identify occlusions, may identify or determine a probability that an external object is occluded, or hidden, by an identified occlusion, and may include occluded vehicle probability information in the operational environment information output to the autonomous vehicle operational management controller 4100, and communicated, by the autonomous vehicle operational management controller 4100, to the respective scenario-specific operational control evaluation modules 4400.

One or more of the SSOCEMs 4400 may be a Decentralized Partially Observable Markov Decision Process (Dec-POMDP) model, which may be a multi-agent model, and which may model a distinct vehicle operational scenario. A Dec-POMDP model may be similar to a POMDP model except that a POMDP model may model the autonomous vehicle and a subset, such as one of external objects and a Dec-POMDP model may model the autonomous vehicle and the set of external objects.

One or more of the SSOCEMs 4400 may be a Partially Observable Stochastic Game (POSG) model, which may be a multi-agent model, and which may model a distinct vehicle operational scenario. A POSG model may be similar to a Dec-POMDP except that the Dec-POMDP model may include a reward function for the autonomous vehicle and the POSG model may include the reward function for the autonomous vehicle and a respective reward function for each external object.

One or more of the SSOCEMs 4400 may be a learning model, for example a Reinforcement Learning (RL) model, and which may model a distinct vehicle operational scenario. An RL model may be similar to an MDP model or a POMDP model except that defined state transition probabilities, observation probabilities, reward function, or any combination thereof, may be omitted from the model.

An RL model may be a model-based RL model, which may include generating state transition probabilities, observation probabilities, a reward function, or any combination thereof based on one or more modeled or observed events. In an RL model, the model may evaluate one or more events or interactions, which may be simulated events, such as traversing an intersection, traversing a vehicle transportation network near a pedestrian, or changing lanes, and may generate, or modify, a corresponding model, or a solution thereof, in response to the respective event. For example, the autonomous vehicle may traverse an intersection using an RL model. The RL model may indicate a candidate vehicle control action for traversing the intersection. The autonomous vehicle may traverse the intersection using the candidate vehicle control action as the vehicle control action for a temporal location. The autonomous vehicle may determine a result of traversing the intersection using the candidate vehicle control action, and may update the model based on the result.

In an example, at a first temporal location a remote vehicle may be stationary at an intersection with a prohibited right-of-way indication, such as a red light, the RL model may indicate a ‘proceed’ candidate vehicle control action for the first temporal location, the RL model may include a probability of identifying operational environment information at a subsequent temporal location, subsequent to traversing the vehicle transportation network in accordance with the identified candidate vehicle control action, indicating that a geospatial location of the remote vehicle corresponding to the first temporal location differs from a geospatial location of the remote vehicle corresponding to the second temporal location is low, such as 0/100. The autonomous vehicle may traverse the vehicle transportation network in accordance with the identified candidate vehicle control action, may subsequently determine that the geospatial location of the remote vehicle corresponding to the first temporal location differs from the geospatial location of the remote vehicle corresponding to the second temporal location, and may modify, or update, the probability accordingly incorporate the identified event, such as to 1/101.

In another example, the RL model may indicate a defined positive expected reward for traversing the vehicle transportation network from a first temporal location to a second temporal location in accordance with an identified vehicle control action and in accordance with identified operational environment information, which may be probabilistic. The autonomous vehicle may traverse the vehicle transportation network in accordance with the identified vehicle control action. The autonomous vehicle may determine, based on subsequently identified operational environment information, which may be probabilistic, that the operational environment information corresponding to the second temporal location is substantially similar to the operational environment information identified corresponding to the first temporal location, which may indicate a cost, such as in time, of traversing the vehicle transportation network in accordance with the identified vehicle control action, and the Reinforcement Learning model may reduce the corresponding expected reward.

The autonomous vehicle operational management system 4000 may include any number or combination of types of models. For example, the pedestrian-scenario-specific operational control evaluation module 4410, the intersection-scenario-specific operational control evaluation module 4420, and the lane change-scenario-specific operational control evaluation module 4430 may be POMDP models. In another example, the pedestrian-scenario-specific operational control evaluation module 4410 may be a MDP model and the intersection-scenario-specific operational control evaluation module 4420 and the lane change-scenario-specific operational control evaluation module 4430 may be POMDP models.

The autonomous vehicle operational management controller 4100 may instantiate any number of instances of the scenario-specific operational control evaluation modules 4400 based on the operational environment information. For example, the operational environment information may include information representing a pedestrian approaching an intersection along an expected path for the autonomous vehicle, and the autonomous vehicle operational management controller 4100 may identify a pedestrian vehicle operational scenario, an intersection vehicle operational scenario, or both. The autonomous vehicle operational management controller 4100 may instantiate an instance of the pedestrian-scenario-specific operational control evaluation module 4410, an instance of the intersection-scenario-specific operation control evaluation module 4420, or both.

In another example, the operational environment information may include information representing more than one pedestrians at or near an intersection along an expected path for the autonomous vehicle. The autonomous vehicle operational management controller 4100 may identify pedestrian operational scenarios corresponding to the one or more pedestrians, an intersection vehicle operational scenario, or a combination thereof. The autonomous vehicle operational management controller 4100 may instantiate instances of the pedestrian-scenario-specific operational control evaluation module 4410 for some or all of the pedestrian operational scenarios, an instance of the intersection-scenario-specific operation control evaluation module 4420, or a combination thereof.

The pedestrian-scenario-specific operational control evaluation module 4410 may be a model of an autonomous vehicle operational control scenario that includes the autonomous vehicle traversing a portion of the vehicle transportation network proximate to a pedestrian (pedestrian scenario). The pedestrian-scenario-specific operation control evaluation module 4410 may receive operational environment information, such as the pedestrian information generated by the pedestrian operational environment monitor 4310, from the autonomous vehicle operational management controller 4100.

The pedestrian-scenario-specific operational control evaluation module 4410 may model pedestrian behavior corresponding to the pedestrian traversing a portion of the vehicle transportation network or otherwise probabilistically affecting the operation of the autonomous vehicle. The pedestrian-scenario-specific operational control evaluation module 4410 may model a pedestrian as acting in accordance with pedestrian model rules expressing probable pedestrian behavior. For example, the pedestrian model rules may express vehicle transportation network regulations, pedestrian transportation network regulations, predicted pedestrian behavior, societal norms, or a combination thereof. For example, the pedestrian model rules may indicate a probability that a pedestrian may traverse a portion of the vehicle transportation network via a crosswalk or other defined pedestrian access area. The pedestrian-scenario-specific operational control evaluation module 4410 may model a pedestrian as acting independently of defined vehicle transportation network regulations, pedestrian transportation network regulations, or both, such as by jaywalking.

The pedestrian-scenario-specific operational control evaluation module 4410 may output a candidate vehicle control action, such as a ‘stop’ candidate vehicle control action, an ‘advance’ candidate vehicle control action, or a ‘proceed’ candidate vehicle control action. The candidate vehicle control action may be a compound vehicle control action. For example, the candidate vehicle control action may include an ‘advance’ vehicle control action, which may be an indirect signaling pedestrian communication vehicle control action, and may include a direct signaling pedestrian communication vehicle control action, such as flashing headlights of the autonomous vehicle or sounding a horn of the autonomous vehicle.

The intersection-scenario-specific operational control evaluation module 4420 may be a model of an autonomous vehicle operational control scenario that includes the autonomous vehicle traversing a portion of the vehicle transportation network that includes an intersection. The intersection-scenario-specific operational control evaluation module 4420 may model the behavior of remote vehicles traversing an intersection in the vehicle transportation network or otherwise probabilistically affecting the operation of the autonomous vehicle traversing the intersection. An intersection may include any portion of the vehicle transportation network wherein a vehicle may transfer from one road to another.

Modeling an autonomous vehicle operational control scenario may include the autonomous vehicle traversing a portion of the vehicle transportation network that includes an intersection may include determining a right-of-way order for vehicles to traverse the intersection, such as by negotiating with remote vehicles. Modeling an autonomous vehicle operational control scenario may include the autonomous vehicle traversing a portion of the vehicle transportation network that includes an intersection may include modeling one or more traffic controls, such as a stop sign, a yield sign, a traffic light, or any other traffic control device, regulation, signal, or combination thereof. Modeling an autonomous vehicle operational control scenario may include the autonomous vehicle traversing a portion of the vehicle transportation network that includes an intersection may include outputting an ‘advance’ candidate vehicle control action, receiving information, such as sensor information, in response to the autonomous vehicle performing the ‘advance’ candidate vehicle control action, and outputting a subsequent candidate vehicle control action based on the received information. Modeling an autonomous vehicle operational control scenario may include the autonomous vehicle traversing a portion of the vehicle transportation network that includes an intersection may include modeling a probability that a remote vehicle may traverse the intersection in accordance with vehicle transportation network regulations. Modeling an autonomous vehicle operational control scenario may include the autonomous vehicle traversing a portion of the vehicle transportation network that includes an intersection may include modeling a probability that a remote vehicle may traverse the intersection independent of one or more vehicle transportation network regulations, such as by following closely behind or piggybacking another remote vehicle having a right-of-way.

The intersection-scenario-specific operational control evaluation module 4420 may output a candidate vehicle control action, such as a ‘stop’ candidate vehicle control action, an ‘advance’ candidate vehicle control action, or a ‘proceed’ candidate vehicle control action. The candidate vehicle control action may be a compound vehicle control action. For example, the candidate vehicle control action may include a ‘proceed’ vehicle control action and a signaling communication vehicle control action, such as flashing a turn signal of the autonomous vehicle.

The lane change-scenario-specific operational control evaluation module 4430 may be a model of an autonomous vehicle operational control scenario that includes the autonomous vehicle traversing a portion of the vehicle transportation network by performing a lane change operation. The lane change-scenario-specific operational control evaluation module 4430 may model the behavior of remote vehicles probabilistically affecting the operation of the autonomous vehicle traversing the lane change.

Modeling an autonomous vehicle operational control scenario may include the autonomous vehicle traversing a portion of the vehicle transportation network by performing a lane change may include outputting ‘maintain’ candidate vehicle control action, a ‘proceed’ vehicle control action, an ‘accelerate’ vehicle control action, a ‘decelerate’ vehicle control action, or a combination thereof.

One or more of the autonomous vehicle operational management controller 4100, the learning monitor 4200, the operational environment monitors 4300, or the SSOCEMs 4400, may operate continuously or periodically, such as at a frequency of ten hertz (10 Hz). For example, the autonomous vehicle operational management controller 4100 may identify a vehicle control action many times, such as ten times, per second. The operational frequency of each component of the autonomous vehicle operational management system 4000 may be synchronized or unsynchronized, and the operational rate of one or more of the autonomous vehicle operational management controller 4100, the learning monitor 4200, the operational environment monitors 4300, or the SSOCEMs 4400 may be independent of the operational rate of another one or more of the autonomous vehicle operational management controller 4100, the learning monitor 4200, the operational environment monitors 4300, or the SSOCEMs 4400.

The candidate vehicle control actions output by the instances of the SSOCEMs 4400 may include, or be associated with, operational environment information, such as state information, temporal information, or both. For example, a candidate vehicle control action may be associated with operational environment information representing a possible future state, a future temporal location, or both. The autonomous vehicle operational management controller 4100 may identify stale candidate vehicle control actions representing past temporal locations, states having a probability of occurrence below a minimum threshold, or unelected candidate vehicle control actions, and may delete, omit, or ignore the stale candidate vehicle control actions.

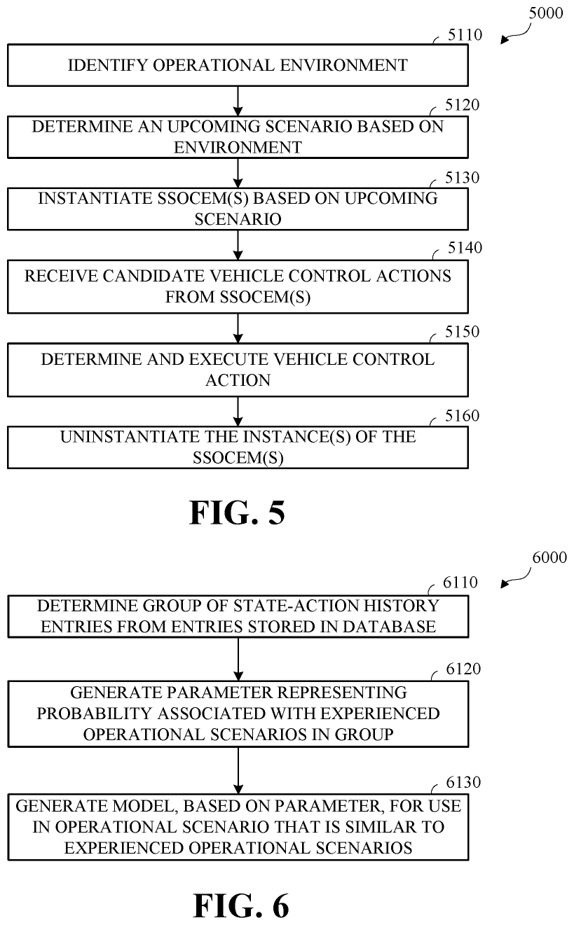

FIG. 5 is a flow chart diagram of an example of a process 5000 for controlling the operation of a vehicle in accordance with embodiments of this disclosure. The process 5000 of FIG. 5 is described with respect to the autonomous vehicle operational management controller 4100. The process 5000 may, however, be executed by any other suitable component.

Although not shown separately in FIG. 5, the autonomous vehicle operational management controller 4100 may identify the operational environment of the autonomous vehicle, or defined aspects thereof, at 5110 while traveling along a route from a current location to a destination. Identifying the operational environment at 5110 can include identifying and tracking external objects.

The identified operational environment may include vehicle information for the vehicle, information representing the vehicle transportation network proximate to the vehicle, information representing external objects, etc. The autonomous vehicle operational management controller 4100 may identify the operational environment at 5110 based on sensor data, such as from the sensor 1360 shown in FIG. 1 or the on-vehicle sensors 2105 shown in FIG. 2, vehicle transportation network information, previously identified operational environment information, or any other information or combination of information describing an aspect or aspects of the operational environment.

An external object indicated by the sensor data may be indeterminate, and the autonomous vehicle operational management controller 4100 may identify object information, such as an object type, based on the sensor data, other information, such as information from another sensor, information corresponding to a previously identified object, or a combination thereof. The sensor, or another unit of the vehicle may identify the object information and may send the object identification information to the autonomous vehicle operational management controller 4100.

At 5120, the autonomous vehicle operational management controller 4100 determines an upcoming scenario. The autonomous vehicle operational management controller 4100 may determine an upcoming scenario by detecting an upcoming scenario itself or may pass the operational environment to one or more of the operational environment monitors 4300 and receive an upcoming scenario detected by a respective operational environment monitor 4300.

Where the autonomous vehicle operational management controller 4100 is used to detect an upcoming scenario, the autonomous vehicle operational management controller 4100 may include one or more scenario-specific monitor module instances. For example, the autonomous vehicle operational management controller 4100 may include such instances for monitoring pedestrians, intersections, lane changes, or a combination thereof. Each scenario-specific monitor module instance may use the operational environment information to determine an upcoming scenario by, for example, identifying whether a pedestrian is within a defined distance of the vehicle, whether the vehicle is approaching an intersection, a crosswalk, or both, whether the vehicle is traveling in a passing lane, etc.

Where the autonomous vehicle operational management controller 4100 passes the operational environment to one or more of the operational environment monitors 4300, similar processing occurs. For instance, the intersection operational environment monitor 4320 may identify, for an upcoming intersection, a type of intersection. For example, the intersection operational environment monitor 4320 may determine the number of roads intersecting, the right of way (if any), whether there are stop signs or traffic signals, and whether there is a crosswalk at the intersection. Each operational environment monitor 4300 may output zero or more upcoming scenarios to the autonomous vehicle operational management controller 4100. Each upcoming scenario may include a geolocation of the upcoming scenario and a type of the upcoming scenario. In some implementations, the type of the upcoming scenario may include one or more data fields that define the features of the upcoming scenario.

In some situations, during travel, the autonomous vehicle operational management controller 4100 determines multiple distinct vehicle operational scenarios, which may be aspects of a compound vehicle operational scenario, at 5120. For example, the operational environment information may include information representing a pedestrian approaching an intersection along an expected path for the vehicle, so a pedestrian vehicle operational scenario, an intersection vehicle operational scenario, or both are determined at 5120. The operational environment may include multiple external objects such that the autonomous vehicle operational management controller 4100 identifies a distinct vehicle operational scenario corresponding to each external object at 5120.

At 5130, the autonomous vehicle operational management controller 4100 instantiates one or more SSOCEMs 4400 based on the upcoming scenario(s). In instantiating a SSOCEM 4400, the autonomous vehicle operational management controller 4100 may pass the geolocation of the upcoming scenario, the current location of the vehicle, and a type of the upcoming scenario to the instance of the SSOCEM 4400. Where more than one SSOCEM 4400 is instantiated at 5130, each SSOCEM instance can correspond to a respective distinct vehicle operational scenario determined at 5120, or a combination of a distinct external object identified in the operational environment at 5110 and a respective distinct vehicle operational scenario determined at 5120.

Although not shown in FIG. 5, the autonomous vehicle operational management controller 4100 may send the operational environment for the vehicle identified at 5110 to a blocking monitor, such as the blocking monitor 4200. The blocking monitor 4200 may then in turn determine a respective probability of availability, or corresponding blocking probability, for one or more portions of the vehicle transportation network, such as portions of the vehicle transportation network corresponding to an expected path of the vehicle (e.g., an expected path identified based on a current route of the autonomous vehicle), an expected path for one or more external objects, etc., and send the probabilities for use in the instantiated SSOCEM(s).

At 5140, the autonomous vehicle operational management controller 4100 receives a candidate action from one or more of the instantiated SSOCEMs. As each SSOCEM may be configured to handle a specific scenario, different SSOCEMs may provide different candidate actions. For instance, a first SSOCEM instance may output a candidate action to stop the vehicle, while a second SSOCEM instance may output a candidate action to decelerate the vehicle.

The SSOCEM instance(s) may solve a model of a corresponding distinct vehicle operational scenario to provide the candidate actions. Solving the model depends on the type of model. For example, where the model for a SSOCEM instance is a POMDP, the solution may determine a set of possible states and state transitions that correspond to vehicle control actions. A model may be considered fully solved when the model converges. A POMDP is defined by a tuple <S, A, Ω, T, O, R>, where S is the set of possible states, A is a set of possible actions, and Ω is a set of observations. T: S×A×S→[0, 1] describes how the environmental states change dynamically with respect to the actions taken by the vehicle. O: A×S×Ω→[0, 1] describes how observations are stochastically produced by new environment states once an action has been taken by the vehicle. R is the reward function, which may be defined as a unit cost for all states, except the goal state. Given the definition of a POMDP, the SSOCEM instance may solve the POMDP by constructing a policy that maximizes an objective function (such as avoiding a pedestrian that may wish to cross the path of the vehicle, or traversing an intersection in the presence of an external objects, such as a remote vehicle). The objective function combines partial rewards (at each step) over multiple steps. At each step, the SSOCEM instance determines whether a state transition, which may be a transition from one state to another state resulting from an action, results in a reward or a penalty. This determination (i.e., reward or penalty) may be used to update the objective function (e.g., decrement the objective function in the case of a penalty and increment the objective function in the case of reward). Thus, the SSOCEM instance iterates through all the possible state transitions while updating the objective function at each step. At each step (or every nth step), the SSOCEM instance can determine whether the objective function is increasing, decreasing, or remaining relatively flat. After observing little or no change in the objective function over multiple steps, the SSOCEM 4400 determines that the solution to the POMDP has converged. The output may comprise the candidate action(s) sent to the autonomous vehicle operational management controller 4100.

At 5150, the autonomous vehicle operational management controller 4100 determines and executes a vehicle control action. The autonomous vehicle operational management controller 4100 may utilize any suitable technique to determine a vehicle control action based on the one or more candidate actions. The autonomous vehicle operational management controller 4100 may implement hard-coded instructions to determine a vehicle control action. For instance, each candidate vehicle control action may have a confidence score associated therewith, and the autonomous vehicle operational management controller 4100 may be configured to select the candidate vehicle control action having the highest confidence score. The autonomous vehicle operational management controller 4100 may select the candidate vehicle control action that is the least likely to cause a collision. The autonomous vehicle operational management controller 4100 may utilize a machine learned model to select the vehicle control action from a set of candidate actions. The autonomous vehicle operational management controller 4100 may group of the candidate actions, and select one or more candidate actions having a highest count as the vehicle control action.

However, the vehicle control action is determined, the autonomous vehicle operational management controller 4100 may execute the vehicle control action. For example, the autonomous vehicle operational management controller 4100 may determine one or more commands for one or more of the vehicle systems (e.g., the chassis system, braking system, steering system, and/or propulsion systems) to perform. Once determined, the autonomous vehicle operational management controller 4100 may issue the determined commands to the respective vehicle systems.

At 5160, the autonomous vehicle operational management controller 4100 may uninstantiate the instance(s) of the SSOCEM(s). Once a particular scenario is handled, the autonomous vehicle operational management controller may uninstantiate any instances of SSOCEMs that were instantiated to handle the scenario. For example, the intersection SSOCEM 4420 may be instantiated when the distance of the autonomous vehicle to the intersection is 50 meters and may be uninstantiated when the vehicle is on the other side of the intersection. As another example, the pedestrian SSOCEM 4410 may be instantiated when the autonomous vehicle approaches a pedestrian or an occluded region of interest and may be uninstantiated when the vehicle has passed the pedestrian or region. As yet another example, the lane change SSOCEM 4430 may be instantiated when the route of the autonomous vehicle requires a lane change, or there is a region-specific preference for a certain lane and may be uninstantiated once the lane change is complete, or the road/route/location changes to make a lane change unnecessary.

Although not expressly shown in FIG. 5, the autonomous vehicle operational management controller 4100 may continuously or periodically repeat identifying or updating the operational environment information at 5110 to determine when a distinct vehicle operational scenario is resolved and hence may be uninstantiated at 5160, or to determine whether a new scenario has appeared that makes the addition of a further SSOCEM instance desirable. To the extent a scenario remains unresolved, the operational environment information may be transmitted to the SSOCEM instances.

As mentioned above, it is impossible to predict every possible scenario and code corresponding solutions for every possible scenario into the autonomous vehicle system. To do so would take countless hours and teams of engineers to code every scenario and/or problem into the autonomous vehicle system. Transfer learning is a technique that may be used to improve the learning process. With transfer learning, a learned solution to one operational scenario implies that it may be used in multiple other scenarios that may be similar. For example, the experiences learned in one intersection about another vehicle performing a rolling stop may be used to improve the model or expected value. This learned experience may be used at a different intersection to improve the vehicle reaction to a rolling stop of another vehicle.

While transfer learning may permit determining responses to multiple scenarios relatively quickly, in some cases, the responses might not be optimal for the scenarios. For example, changing the model or expected value based on an experience at an intersection in a rural region or one part of the world could possibly result in a less optimal response when using the model or expected value at an intersection in an urban region or another part of the world. Thus, techniques described herein may use transfer learning with an experience filter for operation of an autonomous vehicle. A process or method for addressing such transfer learning with experience filtering is described with respect to FIG. 6. More specifically, FIG. 6 is a flow chart diagram of a process 6000 of traversing a vehicle transportation network using transfer learning with experience filtering in accordance with embodiments of this disclosure.

At 6110, a group of state-action history entries may be determined from state-action history entries stored in a database (e.g., from a collection of state-action history entries stored in the database). An individual state-action history entry may include state-action samples (or simply states and actions) that are collected when experiencing an operational scenario, such as traversing an intersection, changing lanes, or encountering a crosswalk. Thus, an individual state-action history entry may represent an experienced operational scenario. A state of a state-action sample could include, for example, sensor data, received from a sensor of the vehicle, which could be collected for a portion of an operational environment during an operational scenario. An action of a state-action sample could include, for example, the vehicle being controlled to stop, edge (e.g., move forward slowly), go (e.g., move forward quickly), or otherwise being controlled with respect to velocity or position. An individual state-action history entry may be stored in the database with one or more features that may be determined when collecting the state-action samples (e.g., the state-action history entry may be categorized based on the one or more features). For example, the features could include a coordinate location, a time of day, a density of traffic, a driver aggressiveness (e.g., speed of one or more other vehicles), an observability, or a vehicle characteristic (e.g., vehicle class, price, or performance).

Thus, an individual state-action history entry may represent an experienced operational scenario. An individual state-action history entry may also be associated with the one or more features. The group of state-action history entries may be determined, from the state-action history entries stored in a database (e.g., from the collection of state-action history entries), based on a similarity of the one or more features. For example, the group may be determined based on state-action history entries having one or more similarities in coordinate location, time of day, density of traffic, driver aggressiveness, observability, and/or vehicle characteristic, observability, or vehicle characteristic. This may result in experience filtering (e.g., filtering the experienced operational scenarios that may be represented in the group).

At 6120, one or more parameters may be generated based on the state-action history entries in the group (e.g., the group of state-action history entries may be parameterized). In some implementations, the group of state-action history entries may be parameterized to have a specific human-understandable term. Processing the one or more parameters (e.g., to generate a model) may be faster and/or more efficient than processing state-actions samples that may be arrayed in a large matrices. A parameter may represent a probability associated with experienced operational scenarios that are similar to one another in the group, such as a probability associated with movement of the autonomous vehicle based on experienced operational scenarios that are similar to one another. For example, the parameter may represent a probability associated with intersections that are similar to one another, lane changes that are similar to one another, or crosswalks that are similar to one another. Examples of probabilities that may be represented by the one or more parameters may include a defined probability of movement of the autonomous vehicle, or a defined probability of movement of another vehicle in the operational environment; a defined probability of another vehicle existing in the operational environment; a defined probability of another vehicle blocking the autonomous vehicle in the operational environment; a defined probability of another vehicle crossing the path of the autonomous vehicle in the operational environment, such as at an intersection; a defined probability of another vehicle changing its choice of blocking the autonomous vehicle in the operational environment; a defined probability of correctly sensing, observing, or otherwise detecting the presence of another vehicle in the operational environment; a defined probability of correctly sensing, observing, or otherwise detecting another vehicle blocking the autonomous vehicle in the operational environment; or any other probabilities associated with states or actions in the operational scenario. In some implementations, the one or more parameters may be generated by averaging the state-action history entries in the group of state-action history. Thus, different parameters, representing different probabilities, may be generated based on the group of state-action history entries that is determined from the collection of state-action history entries that is stored in the database.

At 6130, a model may be generated by a solver based on the one or more parameters. For example, a POMDP model or an MDP model may be generated by the solver based on the one or more parameters. A POMDP model may be similar to an MDP model, except that a POMDP model may include modeling uncertain states. A POMDP model may include modeling confidence, sensor trustworthiness, distraction, noise, uncertainty, such as sensor uncertainty, or the like. A POMDP model may utilize more processing resources and may more accurately model the distinct vehicle operational scenario than an MDP model. In some implementations, the model may be a deep reinforcement learning (DRL) model, and the parameter may be a parameter for the DRL model.

The model may be configured for use in an operational scenario that is similar to the experienced operational scenarios that are similar to one another based on the one or more features. The model may be deployed and used when traversing a portion of the vehicle transportation network (e.g., transfer learning, with the benefit of experience filtering). In particular, the model may be used when encountering an operational scenario that is similar to the experienced operational scenarios. For example, the model may be used when traversing an intersection, changing lanes, or encountering a crosswalk that is similar to experienced intersections, lane changes, or crosswalks, as determined by a similarity in features. The model may be transferred to multiple vehicles in a fleet of vehicles, so that the other vehicles can also use the model when encountering an operational scenario that is similar to the experienced operational scenarios. For example, the model may be transferred to multiple vehicles in a fleet based on a similarity of the multiple vehicles, such as the vehicle characteristic (e.g., vehicle class, price, or performance).

In some implementations, the autonomous vehicle may collect state-action samples when experiencing an operational scenario (e.g., when experiencing traversing an intersection, changing lanes, or encountering a crosswalk). The state-action samples may be collected during a sample period having a duration that may vary, for example, depending on the time to complete the operational scenario. The state-action samples may also be collected according to a sampling rate that may vary, for example, depending on the resolution of data that may be desired. When collecting the state-action samples (e.g., when experiencing the operational scenario, such as traversing the intersection, changing lanes, or encountering the crosswalk), the autonomous vehicle may determine one or more features (e.g., coordinate locations, time of day, density of traffic, driver aggressiveness, observability, or vehicle characteristic) relating to the operational scenario. The autonomous vehicle may store the state-action samples as a state-action history entry in the database (e.g., the experience database), representing an experienced operational scenario. The autonomous vehicle may also store the one or more features as metadata, associated with the state-action history entry, in the database. The metadata may be used to determine whether the related state-action history entry should be part of a group of state-action history entries (e.g., based on a similarity of the one or more features), or blocked from a group of state-action history entries (e.g., based on a difference in the one or more features), when applying the experience filter (e.g., when determining which experienced operational scenarios should be part of a group, based on a similarity of features).

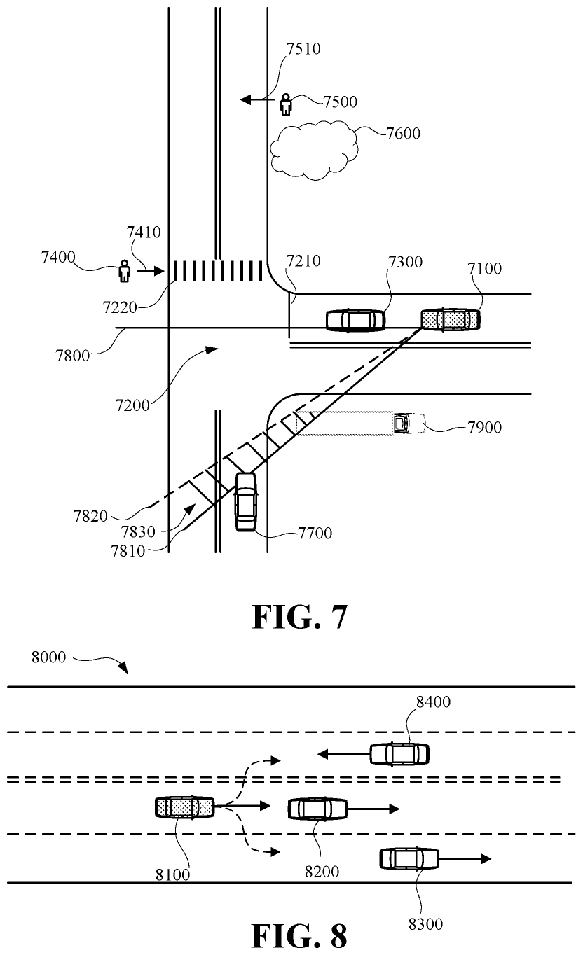

FIG. 7 is a diagram of operational scenarios, including traversing an intersection and encountering a crosswalk, used to explain the process 600 of FIG. 6, and FIG. 8 is a diagram of an operational scenario, including changing lanes, used to explain the process 600 of FIG. 6.

In the diagram of FIG. 7, an autonomous vehicle 7100 is traveling into a T-intersection 7200. The vehicle 7100 is following a remote vehicle 7300 that is approaching a stop line 7210. The T-intersection 7200 includes a crosswalk 7220. Depending upon the spacing of the vehicle 7100 and the remote vehicle 7300, a portion of the crosswalk 7220 and an adjacent portion of the transportation network system may not be detected by a sensor of the vehicle 7100. Together, these portions of the vehicle transportation network form an unobserved region where a pedestrian 7400 may be traveling (i.e., walking or running) in the direction of the arrow 7410 to enter the crosswalk 7220. After the vehicle 7100 takes a right turn and passes the crosswalk 7220, another pedestrian scenario may be considered. Namely, a pedestrian 7500 may be at the side of the road and traveling in a direction indicated by the arrow 7510. This operational environment information may not be unobservable due to an occlusion resulting from the presence of a tree 7600 (and hence forms another unobserved region).

In FIG. 7, another example of an unobserved region 7830 is shown with respect to the T-intersection 7200. A remote vehicle 7700 may be traveling into the T-intersection 7200. The outer bounds of a sensor range for a sensor attached to the left front bumper of the vehicle 7100 are shown by lines 7800 and 7810. A truck 7900 is located in a stationary position adjacent to the T-intersection 7200 such that the truck 7900 interferes with the path of the sensor defined by the lines 7800 and 7810. That is, the truck 7900 results in an occlusion. The cross-hatch between the lines 7810 and 7820 represents the occluded region or area that is unobservable by the vehicle 7100. If the remote vehicle 7700 were traveling into the T-intersection 7200, it would not be observed until the truck 7900 no longer obstructs the sensor of the vehicle 7100 (e.g., through movement of the vehicles 7100, 7700, or the truck 7900). In this example, only one sensor is shown for simplicity. However, sensors may be located such that sensor data is gathered about the entire perimeter of the vehicle.

Thus, the T-intersection 7200 may comprise an operational scenario including traversing an intersection and encountering a crosswalk. The operational scenario may include multiple vehicles, pedestrians, objects, and unobserved regions. For example, the T-intersection 7200 may be in an urban region and/or a first part of the world, such as North America, which may be different from a T-intersection in a rural region and/or a second part of the world, such as Australia. Thus, techniques described herein may use transfer learning with an experience filter to permit navigating the T-intersection 7200, in the urban region and/or the first part of the world, without influence from T-intersections in the rural region and/or the second part of the world. The experience filter may be used to apply state-action history entries that are limited to earlier navigations of T-intersections in similar urban regions and/or the first part of the world (e.g., based on a similarity of one or more features, such as similar coordinate locations and similar observability) in a group of state-action history entries. The group of state-action history entries may be used to generate one or more parameters that may be used to generate a model for navigating the T-intersection 7200 (e.g., traversing the T-intersection 7200 and encountering the crosswalk 7220). Additionally, the experience filter may limit the transfer learning to block state-action history entries from earlier navigations of T-intersections in the different rural regions and/or the second part of the world from the group. As a result, the rate of learning may be improved while providing model accuracy.

In the diagram of FIG. 8, an autonomous vehicle 8100 is traveling along a multi-lane road 8000 (e.g., a four-lane road) in a direction indicated by the solid arrow extending from the vehicle 8100. The vehicle 8100 is following a remote vehicle 8200 that is traveling in the same lane. It may be desirable for the autonomous vehicle 8100 to change lanes, such as when navigating toward a turn or exit. In an adjacent lane, a remote vehicle 8300 travels in the same direction. In another adjacent lane, which is an oncoming lane, a remote vehicle 8400 is traveling in the opposite direction from the vehicle 8100. Depending upon the spacing of the vehicle 8100 and the remote vehicle 8200, and the sensor locations of the sensors of the vehicle 8100, the remote vehicle 8200 may block the sensors from observing the remote vehicle 8300, the remote vehicle 8400, or both. That is, one or more unobserved regions may result.

Thus, the multi-lane road 8000 may comprise an operational scenario including changing lanes. The operational scenario may include multiple vehicles and unobserved regions. For example, the multi-lane road 8000 may be in an urban region and/or a first part of the world, such as North America, which may be different from a multi-lane road in a rural region and/or a second part of the world, such as Australia. Thus, techniques described herein may use transfer learning with an experience filter to permit navigating the multi-lane road 8000, in the urban region and/or the first part of the world, without influence from multi-lane roads in the rural region and/or the second part of the world. The experience filter may be used to apply state-action history entries that are limited to earlier navigations of multi-lane roads in similar urban regions and/or the first part of the world (e.g., based on a similarity of one or more features, such as similar coordinate locations, similar density of traffic, similar driver aggressiveness, and similar observability) in a group of state-action history entries. The group of state-action history entries may be used to generate one or more parameters that may be used to generate a model for navigating the multi-lane road 8000 (e.g., for changing lanes). Additionally, the experience filter may limit the transfer learning to block state-action history entries from earlier navigations of multi-lane roads in the different rural regions and/or the second part of the world from the group. As a result, the rate of learning may be improved while providing model accuracy.

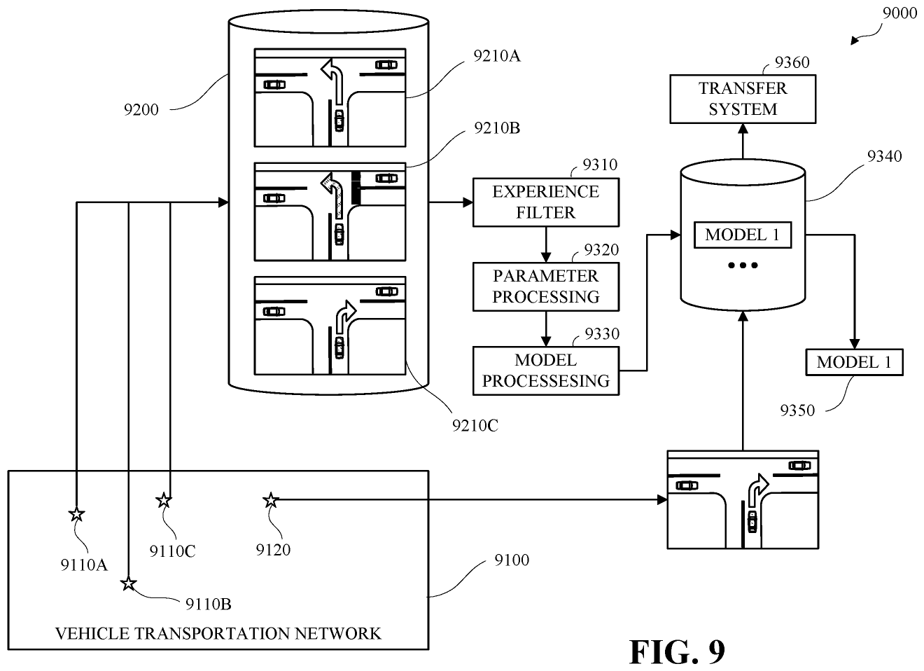

FIG. 9 is a diagram of an example of a system 9000 for using transfer learning with an experience filter to determine a group of state-action history entries. A vehicle transportation network 9100 may include multiple experienced operational scenarios, such as experienced operational scenarios 9110A through 9110C on a map. For example, the experienced operational scenarios 9110A through 9110C could be previous experiences from traversing intersections, like the T-intersection 7200 of FIG. 7, from encountering crosswalks, like the crosswalk 7220 of FIG. 7, or from changing lanes in multi-lane roads, like the multi-lane road 8000 of FIG. 8. The experienced operational scenarios may be stored in a database, such as an experience database 9200, as a collection of state-action history entries, such as state-action history entries 9210A through 9210C. For example, state-action history entry 9210A may correspond to experienced operational scenario 9110A, state-action history entry 9210B may correspond to experienced operational scenario 9110B, and state-action history entry 9210C may correspond to experienced operational scenario 9110C. An individual state-action history entry (e.g., one of the state-action history entries 9210A, 9210B, or 9210C) may include state-action samples that are collected when experiencing the operational scenario (e.g., when experiencing one of the experienced operational scenarios 9110A, 9110B, or 9110C, respectively), such as when traversing the intersection, changing lanes, or encountering the crosswalk. A state of a state-action sample could include, for example, sensor data, received from a sensor of the vehicle, which could be collected for a portion of an operational environment during an operational scenario. An action of a state-action sample could include, for example, the vehicle being controlled to stop, edge (e.g., move forward slowly), go (e.g., move forward quickly), or otherwise being controlled with respect to velocity or position. An individual state-action history entry (e.g., one of the state-action history entries 9210A, 9210B, or 9210C) may be stored in the database with one or more features (e.g., a coordinate location, a time of day, a density of traffic, a driver aggressiveness, an observability, or a vehicle characteristic) that may have been determined when collecting the state-action samples. Thus, an individual state-action history entry may represent an experienced operational scenario, and the state-action history entry may be associated with the one or more features (e.g., may be categorized based on the one or more features).

An experience filter 9310 may determine a group of state-action history entries from state-action history entries stored in the experience database 9200 (e.g., from one or more of the state-action history entries 9210A through 9210C). The experience filter 9310 may determine the group based on a similarity of the one or more features. For example, the group may be determined based on state-action history entries having one or more similarities in coordinate location, time of day, density of traffic, driver aggressiveness (e.g., speed of one or more other vehicles), observability, and/or vehicle characteristic (e.g., vehicle class, price, or performance). This may result in the experience filter 9310 filtering the experienced operational scenarios (e.g., passing only the experienced operational scenarios 9110A through 9110C) that may be represented in the group. For example, the experience filter 9310 may determine that state-action history entries 9210A and 9210C (corresponding to experienced operational scenarios 9110A and 9110C) should be part of the group (e.g., based on a similarity of the one or more features), and/or that state-action history entry 9210B (corresponding to experienced operational scenario 9110B) should be blocked from the group (e.g., based on a difference in the one or more features). Thus, in this example, the group may include only state-action history entries 9210A and 9210C, which may be similar with respect to their one or more features (and not state-action history entry 9210B, which may be different with respect to its one or more features). For example, the experienced operational scenarios 9110A and 9110C may have occurred in similar coordinate locations, at similar times of day, in similar densities of traffic, with similar driver aggressiveness, with similar observability, and/or with similar vehicle characteristics, while the experienced operational scenario 9110B may have occurred in a different coordinate location, at a different time of day, in a different density of traffic, with different driver aggressiveness, with different observability, and/or with different vehicle characteristics.

A parameter processing system 9320 may generate one or more parameters based on the group of state-action history entries determined by the experience filter 9310 (e.g., based on the state-action history entries 9210A and 9210C). A parameter may represent a probability associated with the experienced operational scenarios that are similar to one another (e.g., experienced operational scenarios 9110A and 9110C), such as a probability associated with movement of the autonomous vehicle based on experienced operational scenarios that are similar to one another. For example, the parameter may represent a probability associated with intersections that are similar to one another, lane changes that are similar to one another, or crosswalks that are similar to one another. In some implementations, the one or more parameters may be generated by averaging the state-action history entries in the group of state-action history (e.g., averaging the state-action history entries 9210A and 9210C). In some implementations, the one or more parameters may be stored in a parameter database (not shown).

A model processing system 9330, or solver, may generate a model by solving a process (e.g., POMDP or MDP) using the one or more parameters. For example, a POMDP model or an MDP model may be generated by the model processing system 9330 based on the one or more parameters from the parameter processing system 9320. The model may be configured for use in an operational scenario that is similar to the experienced operational scenarios (e.g., experienced operational scenarios 9110A and 9110C), which are similar to one another based on the one or more features. The model may then be deployed and used when traversing a portion of the vehicle transportation network 9100. For example, the model may be used when encountering the operational scenario 9120 that is similar to the experienced operational scenarios 9110A and 9110C. For example, the model may be used when traversing an intersection, changing lanes, or encountering a crosswalk that is similar to experienced intersections, lane changes, or crosswalks of the experienced operational scenarios 9110A and 9110C, as determined by a similarity in features. The model may be stored in a model database 9340 (e.g., model 1), which may be among multiple other models that are stored for multiple other operational scenarios that may be similar to one another based on one or more features. When encountering the operational scenario 9120, the autonomous vehicle may reference the model database 9340, to access a model 9350 (e.g., model 1) that may be the optimal model for navigating the operational scenario 9120.

In some implementations, a transfer system 9360 may be used to transfer the model (e.g., model 1, or to transfer multiple models in the model database 9340 including model 1), such as to multiple vehicles in a fleet. The model may be transferred to the multiple vehicles so that the multiple vehicles can also use the model when encountering an operational scenario (e.g., the operational scenario 9120) that is similar to the experienced operational scenarios (e.g., the experienced operational scenarios 9110A and 9110C). In some cases, the model generated by the model processing system 9330 (e.g., model 1) may be transferred to multiple vehicles in the fleet based on a similarity of the multiple vehicles, such as a vehicle characteristic (e.g., vehicle class, price, or performance).

In some implementations, after navigating the operational scenario 9120, the operational scenario 9120 may become an experienced operational scenario that may also be stored in the experience database 9200. For example, when navigating the operational scenario 9120, the autonomous vehicle may collect state-action samples. The state-action samples may be collected during a sample period having a duration that may vary, for example, depending on the time to complete the operational scenario 9120. The state-action samples may also be collected according to a sampling rate that may vary, for example, depending on the resolution of data that may be desired. When collecting the state-action samples (e.g., when experiencing the operational scenario 9120), the autonomous vehicle may determine one or more features (e.g., coordinate locations, time of day, density of traffic, driver aggressiveness, observability, or vehicle characteristic) relating to the operational scenario 9120. The autonomous vehicle may store the state-action samples as another state-action history entry (not shown) in the experience database 920, representing the operational scenario 9120 becoming an experienced operational scenario. The autonomous vehicle may also store the one or more features as metadata, associated with the state-action history entry, in the experience database 9200. The metadata may be used by the experience filter 9310 to determine whether the operational scenario 9120, now an experienced operational scenario, should be part of a group of state-action history entries (e.g., based on a similarity of the one or more features), or blocked from a group of state-action history entries (e.g., based on a difference in the one or more features).

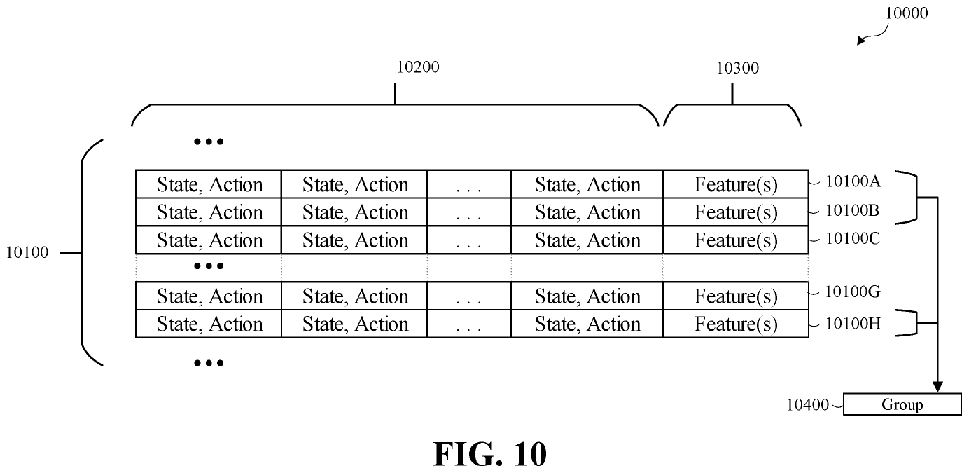

FIG. 10 is a diagram of an example of state-action history entries stored in a database 10000. The database 10000 may be like the experience database 9200 shown in FIG. 9. The database 10000 may include a collection of state-action history entries stored in rows, such as rows 10100. In some implementations, the rows may be sorted based on when the state-action history entries were stored in the database 10000. An individual state-action history entry may include state-action samples that are collected when experiencing an operational scenario, such as when traversing an intersection, changing lanes, or encountering a crosswalk. Thus, an individual state-action history entry may represent an experienced operational scenario. A state of a state-action sample could include, for example, sensor data, received from a sensor of the vehicle, which could be collected for a portion of an operational environment during an operational scenario. An action of a state-action sample could include, for example, the vehicle being controlled to stop, edge (e.g., move forward slowly), go (e.g., move forward quickly), or otherwise being controlled with respect to velocity or position. The state-action samples may be stored in columns, such as columns 10200. Thus, the autonomous vehicle may store state-action samples as state-action history entries in the database 10000, representing experienced operational scenarios.

The state-action samples of a state-action history entry may be collected during a sample period having a duration that may vary, for example, depending on the time to complete the experienced operational scenario. For example, a first row of the rows 10100 may have state-action samples collected during a sample period of 10 seconds, whereas a second row of the rows 10100 may have state-action samples collected during a sample period of 30 seconds. The state-action samples may also be collected according to a sampling rate that may vary, for example, depending on the resolution of data that may be desired. For example, the first row of the rows 10100 may have state-action samples collected with a lower sampling rate of 5 Hz (e.g., 5 samples per second), whereas a second row of the rows 10100 may have state-action samples collected with a higher sampling rate of 10 Hz. Thus, one state-action history entry may have more state-action samples in more columns, or may have less state-action samples in less columns, than another state-action history entry.

When collecting the state-action samples (e.g., when experiencing an operational scenario, such as when traversing an intersection, changing lanes, or encountering a crosswalk), the autonomous vehicle may determine one or more features (e.g., coordinate locations, time of day, density of traffic, driver aggressiveness, observability, or vehicle characteristic) relating to the operational scenario. The autonomous vehicle may store the one or more features as metadata, associated with the state-action history entry, in a column 10300. In some implementations, the rows may be sorted based on when the metadata. The metadata may be used to determine whether particular state-action history entries should be part of a group of state-action history entries, or blocked from a group of state-action history entries, when applying an experience filter like the experience filter 9310 of FIG. 9. In other words, the experience filter may determine the similarity of features associated with state-action history entries stored in the database 10000. For example, based on the one or more features in the column 10300, the experience filter may determine that state-action history entries in adjacent rows 10100A and 10100B should be part of a group 10400, based on a similarity of features in the column 10300, but that a state-action history entry in another adjacent row, such as row 10100C, should not be part of the group 10400 (e.g., should be blocked from the group), based on a difference of features in the column 10300. Additionally, the experience filter may determine that a state-action history entries in non-adjacent rows, such as row 10100G, should be part of the group 10400, based on a similarity of features in the column 10300. In some implementations, the experience filter may determine the similarity of the feature based on a threshold distance (e.g., within an L 2 norm threshold distance) of features associated with state-action history entries stored in the database 10000.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

As used herein, the terminology “determine” and “identify”, or any variations thereof, includes selecting, ascertaining, computing, looking up, receiving, determining, establishing, obtaining, or otherwise identifying or determining in any manner whatsoever using one or more of the devices shown and described herein.

As used herein, the terminology “or” is intended to mean an inclusive “or” rather than an exclusive “or”. That is, unless specified otherwise, or clear from context, “X includes A or B” is intended to indicate any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form.

Further, for simplicity of explanation, although the figures and descriptions herein may include sequences or series of steps or stages, elements of the methods disclosed herein may occur in various orders or concurrently. Additionally, elements of the methods disclosed herein may occur with other elements not explicitly presented and described herein. Furthermore, not all elements of the methods described herein may be required to implement a method in accordance with this disclosure. Although aspects, features, and elements are described herein in particular combinations, each aspect, feature, or element may be used independently or in various combinations with or without other aspects, features, and elements.

The above-described aspects, examples, and implementations have been described in order to allow easy understanding of the disclosure are not limiting. On the contrary, the disclosure covers various modifications and equivalent arrangements included within the scope of the appended claims, which scope is to be accorded the broadest interpretation so as to encompass all such modifications and equivalent structure as is permitted under the law.

What is claimed is:

1. A method for use in traversing a vehicle transportation network, the method comprising:
determining a group of state-action history entries from state-action history entries stored in a database, wherein a state-action history entry represents an experienced operational scenario, wherein a state-action history entry is associated with a feature, and wherein the group of state-action history entries is determined based on a similarity of the feature;
generating a parameter based on the group of state-action history entries, wherein the parameter represents a probability associated with experienced operational scenarios that are determined to be similar to one another; and
generating a model based on the parameter, wherein the model is configured for use in an operational scenario that is similar to the experienced operational scenarios when traversing a portion of the vehicle transportation network.

2. The method of claim 1, wherein the experienced operational scenarios include at least one of:
traversing an intersection;
changing lanes; or
encountering a crosswalk.

3. The method of claim 1, wherein the feature includes at least one of:
a coordinate location;
a time of day;
a density of traffic;
a driver aggressiveness;
or an observability.

4. The method of claim 1, further comprising:
transferring the model to multiple vehicles in a fleet, wherein the model is transferred to the multiple vehicles based on a similarity of the multiple vehicles.

5. The method of claim 1, further comprising:
blocking a first state-action history entry from the group of state-action history entries based on a difference in the feature associated with the first state-action history entry.

6. The method of claim 1, further comprising:
generating the parameter, based on the group of state-action history entries, by averaging state-action history entries in the group of state-action history entries.

7. The method of claim 1, further comprising:
generating the model, based on the parameter, by implementing a Partially Observable Markov Decision Process (POMDP) or a Markov Decision Process (MDP).

8. The method of claim 1, wherein a state-action history entry includes state-action samples, and wherein a first state-action history entry of the group of state-action history entries includes more state-action samples than a second state-action history entry of the group of state-action history entries.

9. The method of claim 1, further comprising:
collecting state-action samples when experiencing an operational scenario;
determining a feature when collecting the state-action samples;
storing the state-action samples as a state-action history entry in the database; and
storing the feature as metadata, associated with the state-action history entry, in the database.

10. The method of claim 1, wherein the parameter represents a probability associated with movement of a vehicle.

11. The method of claim 1, further comprising:
determining the similarity of the feature based on a threshold distance of features associated with state-action history entries stored in the database.

12. The method of claim 1, wherein the model is a deep reinforcement learning (DRL) model, and wherein the parameter is a parameter for the DRL model.

13. An apparatus for use in traversing a vehicle transportation network, the apparatus comprising:
a non-transitory computer readable medium; and
a processor configured to execute instructions stored on the non-transitory computer readable medium to:
determine a group of state-action history entries from state-action history entries stored in a database, wherein a state-action history entry represents an experienced operational scenario, wherein a state-action history entry is associated with a feature, and wherein the group of state-action history entries is determined based on a similarity of the feature;
generate a parameter based on the group of state-action history entries, wherein the parameter represents a probability associated with experienced operational scenarios that are determined to be similar to one another; and
generate a model based on the parameter, wherein the model is configured for use in an operational scenario that is similar to the experienced operational scenarios when traversing a portion of a vehicle transportation network.

14. The apparatus of claim 13, wherein the processor is further configured to execute instructions stored on the non-transitory computer readable medium to:
transfer the model to multiple vehicles in a fleet, wherein the model is transferred to the multiple vehicles based on a similarity of the multiple vehicles.

15. The apparatus of claim 13, the instructions to determine the group of state-action history entries comprise instructions to block a first state-action history entry from the group of state-action history entries based on a difference in the feature associated with the first state-action history entry.

16. The apparatus of claim 13, wherein the instructions to generate the parameter, based on the group of state-action history entries, comprise instructions to average state-action history entries in the group of state-action history entries.

17. The apparatus of claim 13, wherein the instructions to generate the model, based on the parameter, comprise instructions to implement a POMDP or a MDP.

18. The apparatus of claim 13, wherein the processor is further configured to execute instructions stored on the non-transitory computer readable medium to:
collect state-action samples when experiencing an operational scenario;
determine a feature when collecting the state-action samples;
store the state-action samples as a state-action history entry in the database; and
store the feature as metadata, associated with the state-action history entry, in the database.

19. The apparatus of claim 13, wherein the instructions to determine the group of state-action history entries comprise instructions to determine the similarity of the feature based on a threshold distance of features associated with state-action history entries stored in the database.

20. The apparatus of claim 13, wherein the model is a DRL model, and wherein the parameter is a parameter for the DRL mode.
